(19) United States
(12) Patent Application Publication
(10) Pub. No.: US 2024/0178931 A1
(43) Pub. Date: May 30, 2024

(54) UNEQUAL MODULATION ADOPTION AND SIGNALING FOR NEXT GENERATION WIFI

(71) Applicant: NXP USA, Inc., AUSTIN, TX (US)

(72) Inventors: Yan Zhang, Palo Alto, CA (US); Amer Al-Baidhani, San Jose, CA (US); Rui Cao, Sunnyvale, CA (US)

(21) Appl. No.: 18/523,816

(22) Filed: Nov. 29, 2023

Related U.S. Application Data
(60) Provisional application No. 63/385,244, filed on Nov. 29, 2022.
(60) Provisional application No. 63/490,697, filed on Mar. 16, 2023.

(51) Int. Cl. H04L 1/00; H04L 5/00

(52) U.S. Cl. CPC H04L 1/0003; H04L 5/0044; H04W 84/12

(57) ABSTRACT

In an IEEE 802.11 wireless system, a wireless STA is configured to signal a plurality of different spatial stream encoding values to a second STA device in a wireless personal area network in accordance with IEEE 802.11 protocol by generating a signaling physical layer protocol data unit (PPDU) which comprises a dedicated user information field which directly or indirectly identifies a plurality of different modulation and coding selection (MCS) values or different modulation orders used to encode different spatial streams from a plurality of spatial streams Nss used in a beamformed MIMO transmission of a data packet for each scheduled user of the signaling PPDU.

### CROSS-REFERENCE TO RELATED APPLICATION AND PRIORITY CLAIM

This application claims the benefit of U.S. Provisional Patent Application No. 63/385,244, entitled “Unequal Modulations Adoption and Signaling for Next Generation WIFI” filed on Nov. 29, 2022, and U.S. Provisional Patent Application No. 63/490,697 entitled “Unequal Modulation MCS Design and Signaling for Next Generation WIFI” filed Mar. 16, 2023, each of which is incorporated by reference in its entirety as if fully set forth herein.

### BACKGROUND

### Field

The present disclosure is directed in general to communication networks. In one aspect, the present disclosure relates generally to transmit beamforming for MIMO transmission in wireless local area network (WLAN) devices implementing the Institute of Electrical and Electronics Engineers (IEEE) 802.11 standard and any other standards and/or networks that can provide wireless transfer of data in wireless networks.

### Description of the Related Art

An ever-increasing number of relatively inexpensive, low power wireless data communication services, networks and devices have been made available over the past number of years, promising near wire speed transmission and reliability. Enabling technology advances in the area of wireless communications, various wireless technology standards (including for example, the IEEE Standards 802.11a/b/g, 802.11n, 802.11ac, 802.11.ax and their updates and amendments, as well as the IEEE Standard 802.11be now in the process of being adopted) have been introduced that are known to persons skilled in the art and are collectively incorporated by reference as if set forth fully herein fully. These standards specify various methods of establishing connections between wireless communication devices (e.g., access points (APs) or non-AP devices) by transmitting various types of information using different transmission techniques. However, in real world deployments, MIMO channels commonly have large condition numbers which is common for a multipath fading channel. In such situations, the assignment of an equal rate to multiple spatial streams results in the transmit beamforming gain being limited by the weaker spatial streams. As a result, MIMO transmit beamforming would theoretically apply different rates for different spatial streams in order to obtain higher throughput and lower packet error rate (PER) compared to same rate for all spatial streams. However, there are significant technical challenges with using different rates for different spatial streams to maximize performance gain since this would require independent encoding/decoding implementations for each spatial stream.

In recognition that transmit beamforming gain and system performance, such as throughput and latency, can be improved by using unequal modulation without changing code rate between different spatial streams, the IEEE 802.11n standard proposed an optional feature for using unequal modulations with different spatial streams. In order to notify a receiver station (STA) which type of modulation encoding (e.g., equal or unequal) would be used for different streams so that the receiver STA correctly processes the data field (i.e., demodulation, stream de-parsing), the IEEE 802.11n standard proposed that the transmit beamforming STA transmit an “MCS Index” field in high-throughput (HT)-SIG having a 7-bit continuously indexed table of combined MCS and Nss parameters, where selected portions of the table (e.g., table 19-37) included MCS with unequal modulations for multiple streams. In particular, the 802.11n standard describes the MCS indices with “equal modulation” in Tables 19-27 through 19-35 and MCS indices with “unequal modulation” in Tables 19-36 through 19-41. However, there are a number of technical challenges and inefficiencies with using the 802.11n signaling scheme to access a single continuously indexed table of MCS and Nss parameters for differentially modulating multiple spatial streams, including requiring a complex table for parsing MCS and Nss, large signaling overhead when expanding to more modulation orders and coding rates, non-compatibility with existing equal modulation MCS signaling, lack of flexibility with specifying different MCS/modulation combinations, nonuniformity with signaling requirements for equal and unequal modulation MCS, and other disadvantages known to those skilled in the art. As seen from the foregoing, the existing solutions for wireless communications are extremely difficult at a practical level by virtue of the difficulty in efficiently signaling different transmit beamforming modulation encoding schemes used for multiple spatial streams or any new rate in general while balancing requirements for overhead, processing, and flexibility.

### BRIEF DESCRIPTION OF THE DRAWINGS

The present invention may be understood, and its numerous objects, features and advantages obtained, when the following detailed description of a preferred embodiment is considered in conjunction with the following drawings.

FIG. 1 is a block diagram of a wireless local area network (WLAN) in which wireless communication station (STA) devices signal unequal MCS/modulation order encoding for different spatial streams with a defined SIG User Info field or the Trigger frame User info field in accordance with selected embodiments of the present disclosure.

FIGS. 2A-B illustrate variable length user field formats for signaling additional MCS encoding values used to encode different spatial streams for Non-TB (trigger-based) transmission from an AP and STA for SU-MIMO allocations (FIG. 2A) and MU-MIMO allocations (FIG. 2B) in accordance with selected embodiments of the present disclosure.

FIGS. 3A-B illustrate variable length user field formats for signaling differential MCS encoding values used to encode neighboring spatial streams for Non-TB transmission from an AP and STA for SU-MIMO allocations (FIG. 3A) and MU-MIMO allocations (FIG. 3B) in accordance with selected embodiments of the present disclosure.

FIGS. 4A-B illustrate variable length user field formats for individually signaling different modulation order encoding values used to encode different spatial streams for Non-TB transmission from an AP and STA for SU-MIMO allocations (FIG. 4A) and MU-MIMO allocations (FIG. 4B) in accordance with selected embodiments of the present disclosure.

FIGS. 5A-B illustrate variable length user field formats for signaling 2-bit differential modulation order signal encoding values used to encode neighboring spatial streams for non-TB transmission from an AP and STA for SU-MIMO allocations (FIG. 5A) and MU-MIMO allocations (FIG. 5B) in accordance with selected embodiments of the present disclosure.

FIGS. 6A-B illustrate fixed length user field formats for signaling additional MCS signal encoding values used to encode different spatial streams for non-TB transmission from an AP and STA for SU-MIMO allocations (FIG. 6A) and MU-MIMO allocations (FIG. 6B) in accordance with selected embodiments of the present disclosure.

FIGS. 7A-B illustrate fixed length user field formats for signaling 3-bit differential MCS signal encoding values used to encode neighboring spatial streams for non-TB transmission from an AP and STA for SU-MIMO allocations (FIG. 7A) and MU-MIMO allocations (FIG. 7B) in accordance with selected embodiments of the present disclosure.

FIGS. 8A-B illustrate fixed length user field formats for signaling different modulation order signal encoding values used to encode different spatial streams for Non-TB transmission from an AP and STA for SU-MIMO allocations (FIG. 8A) and MU-MIMO allocations (FIG. 8B) in accordance with selected embodiments of the present disclosure.

FIGS. 9A-B illustrate fixed length user field formats for signaling 2-bit differential modulation order signal encoding values used to encode neighboring spatial streams for Non-TB transmission from an AP and STA for SU-MIMO allocations (FIG. 9A) and MU-MIMO allocations (FIG. 9B) in accordance with selected embodiments of the present disclosure.

FIGS. 10A-B illustrate repurposed EHT-SIG user field formats for signaling additional MCS signal encoding values (FIG. 10A) and 3-bit differential MCS signal encoding values (FIG. 10B) used to encode different spatial streams for Non-TB transmission from an AP and STA for SU-MIMO allocations in accordance with selected embodiments of the present disclosure.

FIGS. 10C-D illustrate repurposed EHT-SIG user field formats for signaling 2-bit differential MCS signal encoding values (FIG. 10C) and equal MCS signal encoding values (FIG. 10D) used to encode different spatial streams for Non-TB transmission from an AP and STA for SU-MIMO allocations in accordance with selected embodiments of the present disclosure.

FIGS. 11A-B illustrate repurposed EHT-SIG user field formats for signaling additional modulation order encoding values (FIG. 11A) and 2-bit differential modulation order encoding values (FIG. 11B) used to encode different spatial streams for Non-TB transmission from an AP and STA for SU-MIMO allocations in accordance with selected embodiments of the present disclosure.

FIGS. 11C-D illustrate repurposed EHT-SIG user field formats for signaling 1-bit differential modulation order encoding values (FIG. 11C) and equal modulation order encoding values (FIG. 11D) used to encode different spatial streams for Non-TB transmission from an AP and STA for SU-MIMO allocations in accordance with selected embodiments of the present disclosure.

FIGS. 12A illustrates repurposed EHT-SIG user field formats for signaling differential MCS encoding values used to encode different spatial streams for Non-TB transmission from an AP and STA with MU-MIMO allocations in accordance with selected embodiments of the present disclosure.

FIGS. 12B illustrates repurposed EHT-SIG user field formats for signaling differential modulation order encoding values used to encode different spatial streams for Non-TB transmission from an AP and STA with MU-MIMO allocations in accordance with selected embodiments of the present disclosure.

FIG. 12C illustrates repurposed EHT-SIG user field formats for signaling equal MCS/modulation order encoding values used to encode different spatial streams for Non-TB transmission from an AP and STA with MU-MIMO allocations in accordance with selected embodiments of the present disclosure.

FIGS. 13A-C illustrate repurposed Trigger Frame user field formats for signaling additional MCS encoding values (FIG. 13A), 3-bit differential MCS encoding values (FIG. 13B) and 2-bit differential MCS encoding values (FIG. 13C) used to encode different spatial streams for UL transmission from a STA to an AP in accordance with selected embodiments of the present disclosure.

FIGS. 13D-F illustrate repurposed Trigger Frame user field formats for signaling different modulation order encoding values (FIG. 13D), 2-bit differential modulation order encoding values (FIG. 13E) and 1-bit differential modulation order encoding values (FIG. 13F) used to encode different spatial streams for UL transmission from a STA to an AP in accordance with selected embodiments of the present disclosure.

FIG. 14 depicts a first unequal modulation MCS table which includes MCS index values for accessing entries which list specific combinations of unequal modulation MCS values for encoding two transmitted spatial streams.

FIG. 15 depicts a second unequal modulation MCS table which includes MCS index values for accessing entries which list specific combinations of unequal modulation MCS values for encoding three transmitted spatial streams.

FIG. 16 depicts a third unequal modulation MCS table which includes MCS index values for accessing entries which list specific combinations of unequal modulation MCS values for encoding four transmitted spatial streams.

FIG. 17 depicts an exemplary logic flow diagram illustrating an unequal MCS/modulation order encoding and signaling procedure implemented in accordance with selected embodiments of the present disclosure.

### DETAILED DESCRIPTION

A system, apparatus, and methodology are described for enabling wireless communication station (STA) devices to use different modulation and coding selection (MCS) values and/or unequal modulation orders for different spatial streams when MIMO transmit beamforming is used, and to signal the use of unequal MCS values and/or modulation orders to one or more receiving STA devices with a defined signaling user info field that is transmitted in a PPDU for downlink (DL) or uplink (UL) transmissions in compliance with emerging 802.11 standards, such as 802.11be. In selected embodiments, the transmitting STA device determines whether to use unequal modulations for different spatial streams based on channel condition number statistics or other link adaptation statistics, such as SNR per spatial stream feedback. Upon determining that unequal modulations will be used to a receiver STA device, the transmitting STA device signals to the receiver STA device that unequal modulations will be applied to different spatial streams before transmitting data to the receiver STA device. In selected embodiments, the defined signaling user info field is a fixed or variable length user info field that includes different MCS values being used for different spatial streams, such as by modifying an EHT-SIG User info field to specify the MCS value being applied to each spatial stream or to signal differential MCS values between spatial streams. In other selected embodiments, the defined signaling user info field is a fixed or variable length user info field that includes different modulation order values being used for different spatial streams, such as by modifying an EHT-SIG User info field to specify the different modulation orders being applied to each spatial stream or to signal differential modulation orders between spatial streams. In other selected embodiments, the defined signaling user info field is a variable length user info field that includes additional MCS values being used for different spatial streams, such as by modifying an EHT-SIG User info field to include a Length subfield header and an Additional MCS subfield and bit locations for specifying additional MCS values being applied to each spatial stream for non-trigger based (TB) transmission. In other selected embodiments, the defined signaling user info field is a variable length user info field that includes differential MCS values being used between spatial streams, such as by modifying an EHT-SIG User info field to include a Length subfield header and a Differential MCS subfield and bit locations for specifying differential MCS values being applied between spatial streams for Non-TB transmission. In other selected embodiments, the defined signaling user info field is a variable length user info field that includes different modulation order values being used for different spatial streams, such as by modifying an EHT-SIG User info field to include a Length subfield header and a Modulation Order subfield and bit locations for specifying different modulation order values being applied to each spatial stream for Non-TB transmission. In other selected embodiments, the defined signaling user info field is a variable length user info field that includes differential modulation order values being used for neighboring spatial streams, such as by modifying an EHT-SIG User info field to include a Length subfield header and a Differential Modulation Order subfield and bit locations for specifying differential modulation order values being applied between spatial streams for Non-TB transmission.

In other selected embodiments, the defined signaling user info field may be a fixed length user info field that signals different MCS values and/or modulation orders being used to encode different spatial streams for Non-TB transmission. For example, the defined signaling user info field may be a fixed length user info field that includes additional MCS values being used for different spatial streams, such as by modifying an EHT-SIG User info field to include an Additional MCS subfield and bit locations for specifying additional MCS values being applied to each spatial stream for Non-TB transmission. In other selected embodiments, the defined signaling user info field is a fixed length user info field that includes differential MCS values being used between spatial streams, such as by modifying an EHT-SIG User info field to include a Differential MCS subfield and bit locations for specifying differential MCS values being applied between spatial streams for Non-TB transmission. In other selected embodiments, the defined signaling user info field is a fixed length user info field that includes different modulation order values being used for different spatial streams, such as by modifying an EHT-SIG User info field to include a Modulation Order subfield and bit locations for specifying different modulation order values being applied to each spatial stream for Non-TB transmission. In other selected embodiments, the defined signaling user info field is a fixed length user info field that includes differential modulation order values being used for neighboring spatial streams, such as by modifying an EHT-SIG User info field to include a Differential Modulation Order subfield and bit locations for specifying differential modulation order values being applied between spatial streams for Non-TB transmission.

In other selected embodiments, the defined signaling user info field may be a repurposed or modified EHT-SIG User info field that signals different MCS values and/or modulation orders being used to encode different spatial streams for Non-TB transmission. For example, the defined signaling user info field may be a repurposed EHT-SIG User info field that includes an Equal MCS subfield (to indicate whether different MCS values will be used) and an Additional MCS subfield for specifying additional MCS values being applied to each spatial stream for Non-TB transmission. In other selected embodiments, the defined signaling user info field is a repurposed EHT-SIG User info field that includes an Equal MCS subfield (to indicate whether different MCS values will be used) and a Differential MCS subfield for specifying differential MCS values being applied between spatial streams for Non-TB transmission. In other selected embodiments, the defined signaling user info field is a repurposed EHT-SIG User info field that includes an Equal Modulation subfield (to indicate whether different modulation order values will be used) and a Modulation Order subfield for specifying different modulation order values being applied to each spatial stream for Non-TB transmission. In other selected embodiments, the defined signaling user info field is a repurposed EHT-SIG User info field that includes an Equal Modulation subfield (to indicate whether different modulation order values will be used) and a Differential Modulation Order subfield for specifying differential modulation order values being applied between spatial streams for Non-TB transmission. In other selected embodiments, the defined signaling user info field is a repurposed EHT-SIG User info field that includes an Equal MCS subfield (to indicate whether different MCS values will be used) and the MCS subfield is repurposed to specify new MCSs being applied to all spatial streams for non-TB transmission. The new MCS table can be Nss dependent.

In other selected embodiments, the defined signaling user info field may be a repurposed or modified Trigger frame User info field that signals different MCS values and/or modulation orders being used to encode different spatial streams for UL triggered based transmission. For example, the defined signaling user info field may be a repurposed Trigger frame User info field that includes an Equal MCS subfield (to indicate whether different MCS values will be used) and an Additional MCS subfield for specifying additional MCS values being applied to each spatial stream for UL transmission. In other selected embodiments, the defined signaling user info field is a repurposed Trigger frame User info field that includes an Equal MCS subfield (to indicate whether different MCS values will be used) and a Differential MCS subfield for specifying differential MCS values being applied between spatial streams for UL transmission. In other selected embodiments, the defined signaling user info field is a repurposed Trigger frame User info field that includes an Equal Modulation subfield (to indicate whether different modulation order values will be used) and a Modulation Order subfield for specifying different modulation order values being applied to each spatial stream for UL transmission. In other selected embodiments, the defined signaling user info field is a repurposed Trigger frame User info field that includes an Equal Modulation subfield (to indicate whether different modulation order values will be used) and a Differential Modulation Order subfield for specifying differential modulation order values being applied between spatial streams for UL transmission. In other selected embodiments, the defined signaling user info field is a repurposed Trigger frame User info field that includes an Equal MCS subfield (to indicate whether different MCS values will be used) and the MCS subfield is repurposed to specify new MCSs being applied to all spatial streams for UL TB transmission. The new MCS table can be Nss dependent.

In the context of the present disclosure, it will be understood by those skilled in the art that that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present disclosure may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

References throughout this specification to “one embodiment”, “an embodiment,” “selected embodiments,” or similar language means that a particular feature, structure, or characteristic described in connection with the indicated embodiment is included in at least one embodiment of the present disclosure. Thus, the phrases “in one embodiment”, “in an embodiment,” “selected embodiments,” and similar language throughout this specification may, but do not necessarily, all refer to the same embodiment.

As indicated above, using the same or equal rate for different spatial streams when a MIMO channel has a large condition number is not optimal in term of capacity. To have error free or tolerable error level transmission while maximizing throughput, stronger spatial streams most likely operate at lower rates which the corresponding spatial subchannels can support, and weaker spatial streams most likely operate at higher rate which the corresponding spatial subchannels can support. The final PER performance and throughput are bottlenecked by the weaker streams. To address this limitation and improve transmit beamforming gain, different rates may be used for different spatial streams when transmit beamforming is used with MIMO channels having a large condition number (e.g., better PER is achieved for the same effective rate transmission as equal modulation rate, thereby resulting in higher throughput). Indeed, transmit beamforming gain can be fully exploited when the rate assigned for each spatial stream approaches its own capacity. While there are encoding and decoding challenges that arise from using different rates for different spatial streams, unequal modulation without changing the code rate can be another option for easier implementation to improve system performance, such as throughput and latency. While this approach was recognized with the IEEE 802.11n standard which introduced the optional feature of using unequal modulations for different spatial streams MIMO transmit beamforming, this feature is no longer adopted in the later standards, such as IEEE 802.11ac, 802.11ax and 802.11be.

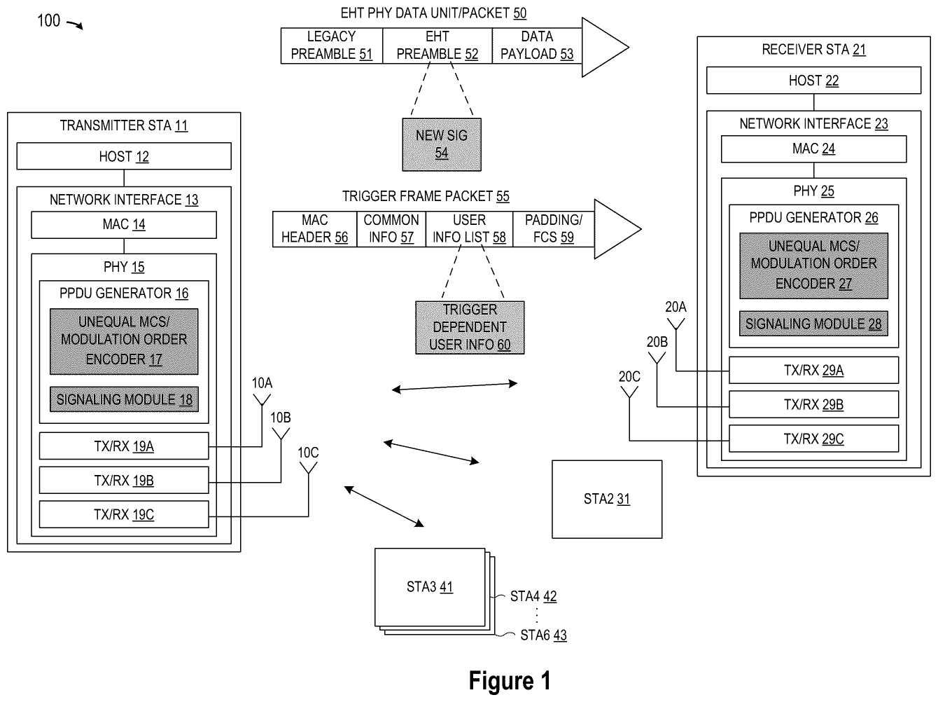

To provide a contextual understanding for selected embodiments of the present disclosure, reference is now made to FIG. 1 which depicts a block diagram of a wireless local area network (WLAN) 100 in which a transmitter access point (AP) station (STA) 11 and one or more wireless devices 21, 31, 41-43 use MIMO transmit beamforming to transmit and receive data packets. As depicted, the transmitter STA 11 includes a host processor 12 coupled to a network interface 13. In selected embodiments, the network interface 13 includes one or more integrated circuits (IC) devices configured to operate a local area network (LAN) protocol. To this end, the network interface 13 may include a medium access control (MAC) processor 14 and a physical layer (PHY) processor 15. In selected embodiments, the MAC processor 14 is implemented as an 802.11be MAC processor 14, and the PHY processor 15 is implemented as an 802.11be PHY processor 15. The PHY processor 15 includes a plurality of transceivers 19A-C which are coupled to a plurality of antennas 10A-C. Although three transceivers 19A-C and three antennas 10A-C are illustrated, the transmitter STA 11 may use any suitable number of transceivers 19 and antennas 10 in other embodiments. In addition, the transmitter STA 11 may have more antennas 10 than transceivers 19, in which case antenna switching techniques are used to switch the antennas 10 between the transceivers 19. In selected embodiments, the MAC processor 14 is implemented with one or more integrated circuit (IC) devices, and the PHY processor 15 is implemented on one or more additional IC devices. In other embodiments, at least a portion of the MAC processor 14 and at least a portion of the PHY processor 15 are implemented on a single IC device. In various embodiments, the MAC processor 14 and the PHY processor 15 are configured to operate according to at least a first communication protocol (e.g., 802.11be). In other embodiments, the MAC processor 14 and the PHY processor 15 are also configured to operate according to one or more additional communication protocols (e.g., according to the IEEE 802.11ax Standard). Using the communication protocol(s), the transmitter STA 11 is operative to create a wireless local area network (WLAN) 100 in which one or more client stations (e.g., 21) may communicate with the transmitter STA 11 and/or with other client stations (e.g., 31, 41) located within the WLAN 100. Although five client stations 21, 31, 41-43, are illustrated in FIG. 1, the WLAN 100 may include any suitable number of client stations in various scenarios and embodiments.

At least one of the client stations (e.g., client station 21) is configured to operate as a receiver STA in accordance with the first communication protocol. To this end, the receiver STA 21 includes a host processor 22 coupled to a network interface 23. In selected embodiments, the network interface 23 includes one or more IC devices configured to operate as discussed below. For example, the depicted network interface 23 may include a MAC processor 24 and a PHY processor 25. In selected embodiments, the MAC processor 24 is implemented as an 802.11be MAC processor 24, and the PHY processor 25 is implemented as an 802.11be PHY processor 25. The PHY processor 25 includes a plurality of transceivers 29A-C coupled to a plurality of antennas 20A-C. Although three transceivers 29A-C and three antennas 20A-C are illustrated, the receiver STA 21 may include any suitable number of transceivers 29 and antennas 20. In addition, the receiver STA 21 may include more antennas 20 than transceivers 29, in which case antenna switching techniques are used. In selected embodiments, the MAC processor 24 is implemented on at least a first IC device, and the PHY processor 25 is implemented on at least a second IC device. In other embodiment, at least a portion of the MAC processor 24 and at least a portion of the PHY processor 25 are implemented on a single IC device. As will be appreciated, one or more of the client stations 31, 41-43 may have a structure that is the same as or similar to the receiver STA 21, though there can be structural differences.

As disclosed herein, the transmitter STA 11 transmits data streams to one or more client stations 21, 31, 41-43 in the WLAN 100. The transmitter STA 11 is configured to operate with client stations (e.g., 21) according to at least a first communication protocol which may be referred to as “extremely high throughput” or EHT communication protocol or IEEE 802.11be communication protocol. In some embodiments, different client stations in the vicinity of the transmitter STA 11 are configured to operate according to one or more other communication protocols which define operation in some of the same frequency band(s) as the EHT communication protocol but with generally lower data throughputs. Such lower data throughput communication protocols (e.g., IEEE 802.11a, IEEE 802.11n, IEEE 802.11ac and/or 802.11ax) are collectively referred herein as “legacy” communication protocols.

In the context of the present disclosure, it will be understood by those skilled in the art that the IEEE 802.11 standard (a.k.a., Wi-Fi) has been amended to provide very high data throughput performance in real-world, high density scenarios. For example, there are advanced Physical Layer techniques being addressed in IEEE 802.11be standard which add more flexibility to the orthogonal frequency-division multiple access (OFDMA) modulation schemes by increasing (i) the number of modulation and coding schemes (MCS) for a total of 16 MCS options, (ii) the order of modulation up to 4096-QAM, and (iii) the number of total spatial streams in MU-MIMO up to 8. As a result, the IEEE 802.11be standard provides a total of 16 modulation and coding selections (MCS) with MCS14 and MCS15 supporting only a single spatial stream and with MCS values ranging from MCS0 to MCS13 being available for different spatial streams. In addition, the IEEE 802.11be standard Up to 802.11be standard provides 7 different modulation orders (BPSK, QPSK, 16QAM, 64QAM, 256QAM, 1024QAM and 4096QAM). Unfortunately, existing 802.11 wireless encoding schemes do not support the new MCS schemes and/or higher order modulation schemes being applied to encode the additional spatial multiplexing streams.

With the additional unequal modulation combinations for different spatial streams provided in the 802.11be standard, the number of MCS values could be expanded, as was done with the 802.11n standard. Unfortunately, the capability signaling mechanism of 802.11n standard does not provide a mechanism for signaling unequal combinations of all MCS values and modulation orders that could be differentially applied to multiple spatial streams. For example, simply expanding the 802.11n MCS index values to include all possible beneficial unequal MCS/modulation combinations to cover all possible channel conditions can be a very daunting task due to the maximum spatial streams support (8 streams as of today) and the number of modulation orders (7 modulation orders as of today) adopted in current WIFI standard. As a result, the data encoding and signaling schemes from 802.11be must be modified to support differential encoding of multiple spatial streams using the expanded MCS values and modulation orders, while at the same time continuing to satisfy all the current use cases requirements and ensure backwards compatibility to existing IEEE 802.11 standards.

To address these and other shortcomings of the existing 802.11 capability signaling capabilities, an 802.11-compliant information field is provided to signal the different modulation orders applied to the different spatial streams to the receiver for data reception. To this end, each transmitting STA device (e.g., transmitter STA 11) includes an unequal MCS/modulation order encoder (e.g., 17) which is configured to encode multiple spatial streams with unequal MCS/modulation encoding for Non-TB transmission. In addition, each transmitting STA device includes a signaling module (e.g., 18) to separately signal different or unequal MCS values or modulation orders that are applied to multiple spatial streams. And in embodiments where the feedback of SNRs for different spatial streams are arranged in a non-ascending order, each signaling module (e.g., 18) may differentially signal different or unequal MCS values or modulation orders that are applied between spatial streams by conveying a differential MCS value between the two neighboring spatial streams to the receiver for data reception. In selected embodiments of the present disclosure, the transmitter STA device 11 uses the signaling module 18 to generate a defined SIG User Info field 54 in the EHT PHY data unit/packet 50 which specifies the unequal modulation information being used by the transmitter STA device 11 so that receiver STA device 21 can correctly process the subsequently received data packet. In similar fashion, the non-AP STA device 21 uses the unequal MCS/modulation order encoder 27 to encode multiple spatial streams with unequal MCS/modulation encoding for UL transmission, and uses the signaling module 28 to generate a defined Trigger frame User info field 60 in the Trigger Frame packet 55 which specifies the unequal modulation information being used by the non-AP STA device 21 so that receiving transmitter STA device 11 can correctly process the subsequently received data packet. As will be understood by those skilled in the art, a “UL transmission” refers to a “trigger based transmission,” where the receiver is the access point (AP) STA, and the transmitter is the non-AP STA.

In selected embodiments for signaling unequal modulation information to a receiver 21, the transmitter STA 11 may include a PPDU generator module 16 which is configured to generate a New PHY data unit or packet frame 50 which has a legacy preamble portion 51, a New preamble portion 52, and an (optional) data payload portion 53. The contents of the legacy and New preamble portions 51, 52 are known to those skilled in the art, and will not be detailed other than to note that the EHT preamble portion 52 may include a defined SIG User Info field 54 having common information field (with information for all users) and a user-specified field (with information about MCS, modulation order, the number of spatial streams (Nss), coding, the duration of the guard interval (GI setting), RU/MRU configuration or allocation, etc.). As set forth more fully hereinbelow, the defined SIG User Info field 54 may be a fixed or variable length user info field that specifies the MCS and/or modulation order values being applied individually or differentially to multiple spatial streams for use in DL MIMO transmissions. As will be understood by those skilled in the art, a “DL transmission” refers to a “non-trigger-based transmission,” where the transmitter can be either an access point (AP) or non-AP STA.

In similar fashion, the non-AP 21 may signal unequal modulation information to the transmitter STA 11 with the PPDU generator module 26 which is configured to generate a Trigger Frame packet frame 55 which has a MAC header portion 56, a common info portion 57, a user info list 58, and additional padding/FCS portion 59. The contents of the Trigger Frame packet frame 55 are known to those skilled in the art, and will not be detailed other than to note that the user info list portion 58 may include a defined Trigger-Dependent User Info field 60 having specified fields with information about MCS, modulation order, the number of spatial streams (Nss), coding, etc. As set forth more fully hereinbelow, the defined Trigger-Dependent User Info field 60 may be a fixed or variable length user info field that specifies the MCS and/or modulation order values being applied individually or differentially to multiple spatial streams for use in UL MIMO transmissions.

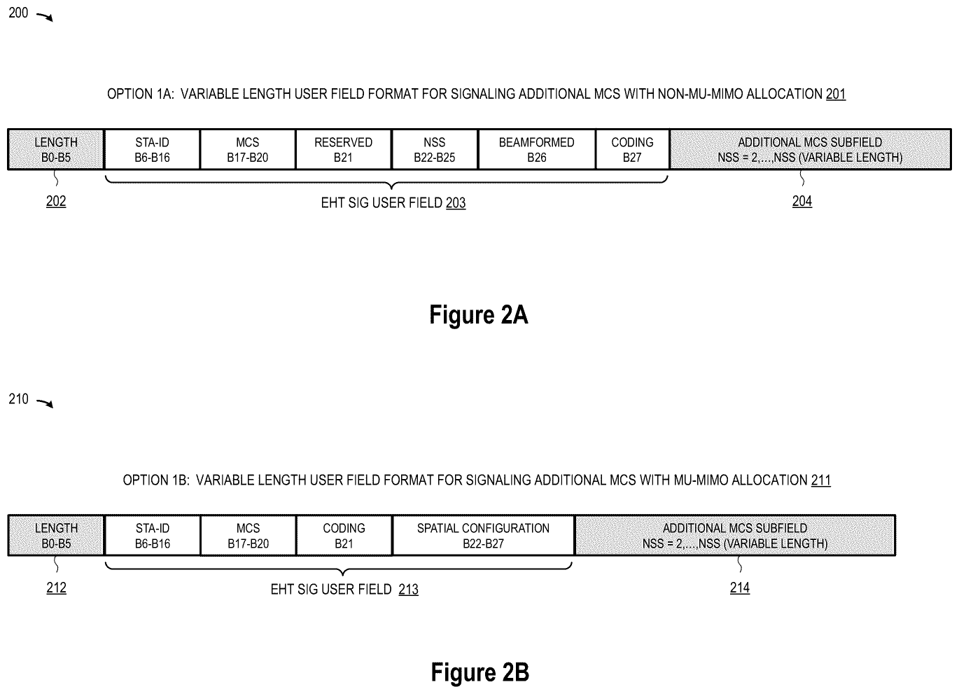

To provide additional details for an improved understanding of selected embodiments of the present disclosure, reference is now made to FIG. 2A which illustrates a New SIG User Info field 200 (option 1A) having a variable length user field format 201 for signaling additional MCS encoding values used to encode different spatial streams for non-TB transmission with non-MU-MIMO allocations. As depicted, the New SIG User Info field 200 includes a Length subfield 202 (bit positions B0-B5), an EHT-SIG user field 203 (bit positions B6-B27), and a variable length Additional MCS subfield 204 for specifying additional MCS values being applied to encode multiple spatial streams for non-TB transmission. The EHT-SIG user field 203 specifies a base MCS with the MCS subfield (bit positions B17-B20) for the MIMO transmission (for example, the MCS value for the first spatial stream (nₛₛ=1)), and the Additional MCS subfield 204 includes additional MCS values that are used for encoding additional spatial streams nₛₛ=2, . . . , Nₛₛ if at least one of the spatial streams is assigned to a MCS value different than the base MCS. In the indicated signaling option 1A, the New SIG User Info field 200 specifies or signals the MCS value for each spatial stream individually, and thus the number of bits of Additional MCS field is variable depending on the number of spatial streams (Nss). As an example, the number of bits of the New SIG User Info field 200 varies from 22 (when equal MCS is used for multiple streams) to 22+(Nₛₛ−1)*4 (when there is unequal MCS is used for multiple streams with 4 bits for each spatial stream). With up to 8 spatial streams, the number of bits in the New SIG User Info field 200 (excluding Length field) expands up to 50 bits.

As disclosed herein, the number of bits of each New SIG User Info field 200 may vary since each user may have a different number of spatial streams. In addition or in the alternative, the number of bits of each user info field may vary since each user may (or may not) use different MCS values for different spatial streams. To facilitate receiver STAs to parse each user info field correctly, each receiver STA needs to know the start and end of each user info field to extract relevant information for reception. To this end, the Length subfield 202 is added at the beginning of each New SIG User Info field 200 to indicate the total number of bits of the remaining subfields (from STA-ID subfield to the end of the New SIG User Info field 200).

To provide additional details for an improved understanding of selected embodiments of the present disclosure, reference is now made to FIG. 2B which illustrates a New SIG User Info field 210 (option 1B) having a variable length user field format 211 for signaling additional MCS encoding values used to encode different spatial streams for DL transmission with MU-MIMO allocations. As depicted, the New SIG User Info field 210 includes a Length subfield 212 (bit positions B0-B5), an EHT-SIG user field 213 (bit positions B6-B27), and a variable length Additional MCS subfield 214 for specifying additional MCS values being applied to encode multiple spatial streams for DL transmission. The EHT-SIG user field 213 specifies a base MCS value with the MCS subfield (bit positions B17-B20) (for example, the MCS for the first spatial stream (nₛₛ=1),) and the Additional MCS subfield 214 includes additional MCS values that are used for encoding additional spatial streams nₛₛ=2, . . . , Nₛₛ if at least one of the spatial streams is assigned to a MCS value different than the base MCS. In the indicated signaling option 1B, the New SIG User Info field 210 individually specifies or signals the MCS value for each spatial stream, so the number of bits varies and must be signaled to the receiver STA with the Length subfield 212 that is added at the beginning of each New SIG User Info field 210 to indicate the total number of bits of the remaining subfields of the New SIG User Info field 210.

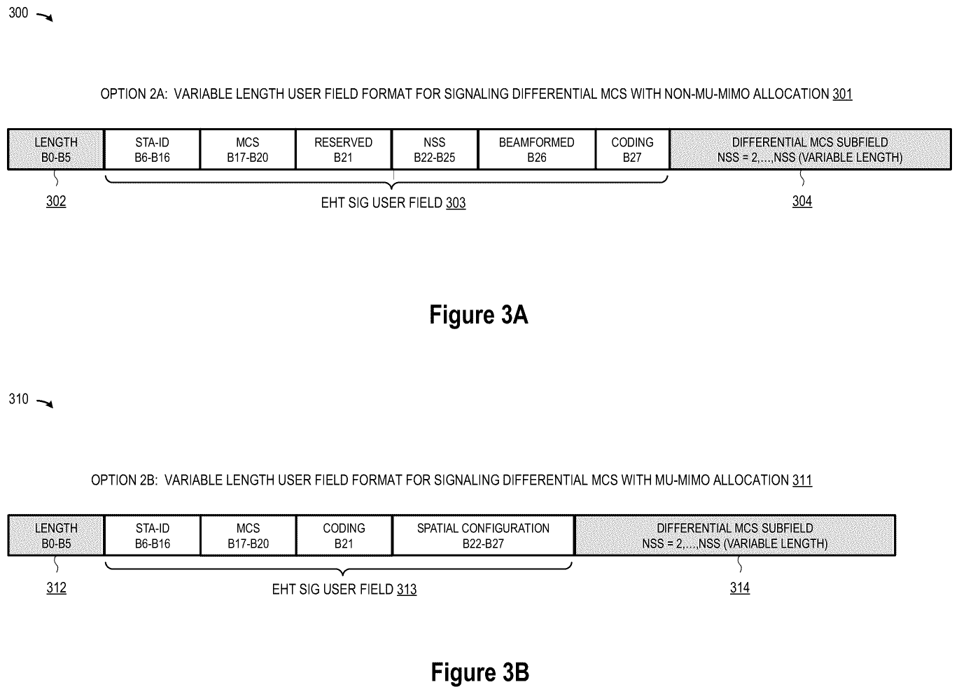

To provide additional details for an improved understanding of selected embodiments of the present disclosure, reference is now made to FIG. 3A which illustrates a New SIG User Info field 300 (option 2A) having a variable length user field format 301 for signaling differential MCS encoding values used to encode neighboring spatial streams for non-TB transmission with non-MU-MIMO allocations. As depicted, the New SIG User Info field 300 includes a Length subfield 302 (bit positions B0-B5), an EHT-SIG user field 303 (bit positions B6-B27), and a variable length Differential MCS subfield 304. The EHT-SIG user field 303 specifies a base MCS value with the MCS subfield (bit positions B17-B20) (for example, the MCS for the first spatial stream (nₛₛ=1)), and the Differential MCS subfield 304 specifies the differential MCS values for all spatial streams, for example, the Differential MCS subfield 304 is encoded as the MCS difference of neighboring spatial streams. For MIMO channels with large condition numbers, 3 bits are enough to signal the differential MCS value (i.e., the difference of MCS values is up to 7). To further reduce overhead, 2 bits can be used to signal the differential MCS value (i.e., the difference of MCS values is up to 3), thereby providing a tradeoff between performance and overhead. Since the Differential MCS subfield 304 includes differential MCS values that are used for encoding each additional spatial streams nₛₛ=2, . . . , Nₛₛ if at least one of the spatial streams is assigned to a MCS value different than the base MCS, the New SIG User Info field 300 has a variable length depending on the total number of Nss. For example, the number of bits varies from 22 (when equal modulation is used for multiple streams) to 22+(Nₛₛ−1)*2 (when unequal modulation is used and 2-bit differential MCS is used) or to 22+(Nₛₛ−1)*3 (when unequal modulation is used and 3-bit differential MCS is used). With up to 8 spatial streams, the number of bits in the New SIG User Info field 300 (excluding Length field) expands up to 36 bits (for 2-bit differential MCS values) or 43 bits (for 3-bit differential MCS values). In the indicated signaling option 2A, the number of bits must be signaled to the receiver STA with the Length subfield 302 that is added at the beginning of each New SIG User Info field 300 to indicate the total number of bits of the remaining subfields of the New SIG User Info field 300.

To provide additional details for an improved understanding of selected embodiments of the present disclosure, reference is now made to FIG. 3B which illustrates a New SIG User Info field 310 (option 2B) having a variable length user field format 311 for signaling differential MCS encoding values for DL transmission with MU-MIMO allocations. As depicted, the New SIG User Info field 310 includes a Length subfield 312 (bit positions B0-B5), an EHT-SIG user field 313 (bit positions B6-B27), and a variable length Differential MCS subfield 314 for specifying differential MCS values for Non-TB transmission. The EHT-SIG user field 313 specifies a base MCS value with the MCS subfield (bit positions B17-B20) (for example, the MCS value of the first spatial stream (nₛₛ=1)), and the Differential MCS subfield 314 includes differential MCS values that are used for encoding the rest of the spatial streams nₛₛ=2, . . . , Nₛₛ if at least one of the spatial streams is assigned to a different MCS value. In the example signaling option 2B, the New SIG User Info field 310 differentially signals the MCS values between neighboring spatial streams, so the number of bits varies and must be signaled to the receiver STA with the Length subfield 312 that is added at the beginning of each New SIG User Info field 310 to indicate the total number of bits of the remaining subfields of the New SIG User Info field 310.

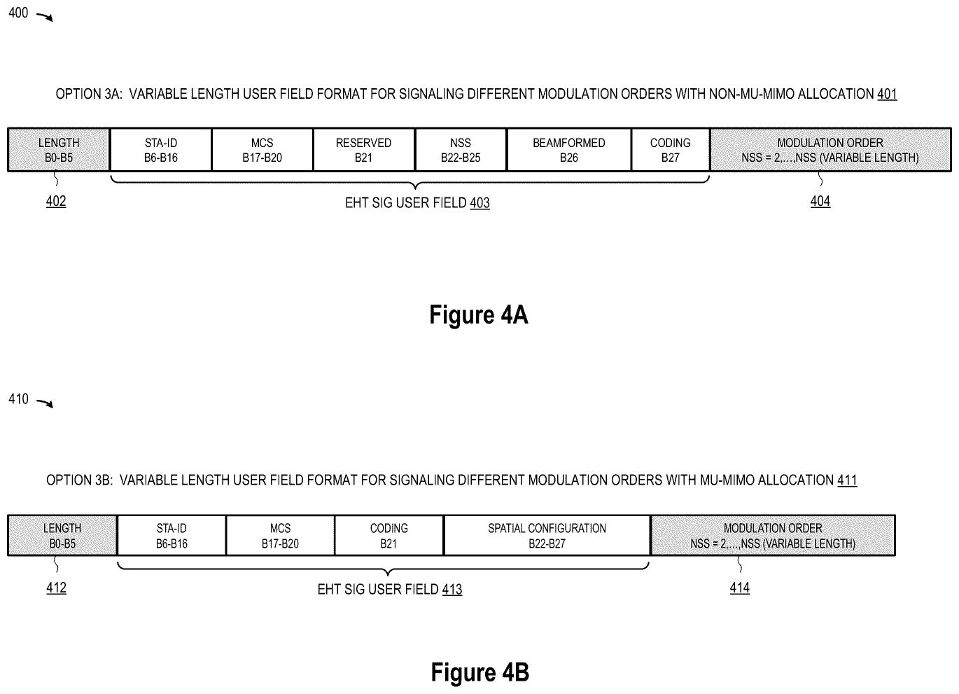

To provide additional details for an improved understanding of selected embodiments of the present disclosure, reference is now made to FIG. 4A which illustrates a New SIG User Info field 400 (option 3A) having a variable length user field format 401 for signaling different modulation orders that are assigned to different spatial streams for Non-TB transmission with non-MU-MIMO allocations. As depicted, the New SIG User Info field 400 includes a Length subfield 402 (bit positions B0-B5), an EHT-SIG user field 403 (bit positions B6-B27), and a Modulation Order subfield 404 for specifying different modulation orders being assigned to different spatial streams for Non-TB transmission. The EHT-SIG user field 403 specifies a base MCS (indicating the modulation order) with the MCS subfield (bit positions B17-B20) (for example, the MCS value of the first spatial stream (nₛₛ=1)), and the Modulation Order subfield 404 includes modulation order values that are assigned to the additional spatial streams nₛₛ=2, . . . , Nₛₛ if at least one of the spatial streams is assigned to a modulation order different than the one applied to the first spatial stream. In the indicated signaling option 3A, the New SIG User Info field 400 signals the modulation order of each spatial stream individually, thus the number of bits for Modulation Order subfield 404 varies with the total number of spatial streams, Nₛₛ. For example, the number of bits included in the New SIG User Info field 400 varies from 22 (when equal modulation is used for all streams) to 22+(Nₛₛ−1)*3 (when unequal modulation is used and 3-bit is used for the modulation order). With up to 8 spatial streams, the number of bits in the New SIG User Info field 400 (excluding Length field) expands up to 43 bits. Since the number of bits must be signaled to the receiver STA, the Length subfield 402 is added at the beginning of each New SIG User Info field 400 to indicate the total number of bits of the remaining subfields of the New SIG User Info field 400.

To provide additional details for an improved understanding of selected embodiments of the present disclosure, reference is now made to FIG. 4B which illustrates a New SIG User Info field 410 (option 3B) having a variable length user field format 411 for signaling different modulation orders that are assigned to different spatial streams for DL transmission with MU-MIMO allocations. As depicted, the New SIG User Info field 410 includes a Length subfield 412 (bit positions B0-B5), an EHT-SIG user field 413 (bit positions B6-B27), and a variable length Modulation Order subfield 414 for specifying different modulation orders being assigned to different spatial streams. The EHT-SIG user field 413 specifies a base MCS value (indicating the modulation order) with the MCS subfield (bit positions B17-B20) (for example, the MCS value of the first spatial stream (nₛₛ=1)), and the Modulation Order subfield 414 includes modulation order values that are assigned to spatial streams nₛₛ=2, . . . , Nₛₛ if at least one of the spatial streams is assigned to a modulation order different from the base MCS. In the indicated signaling option 3B, the New SIG User Info field 410 specifies or signals the modulation order assigned to each spatial stream individually, so the number of bits varies with the number of spatial streams and must be signaled to the receiver STA with the Length subfield 412 that is added at the beginning of each New SIG User Info field 410.

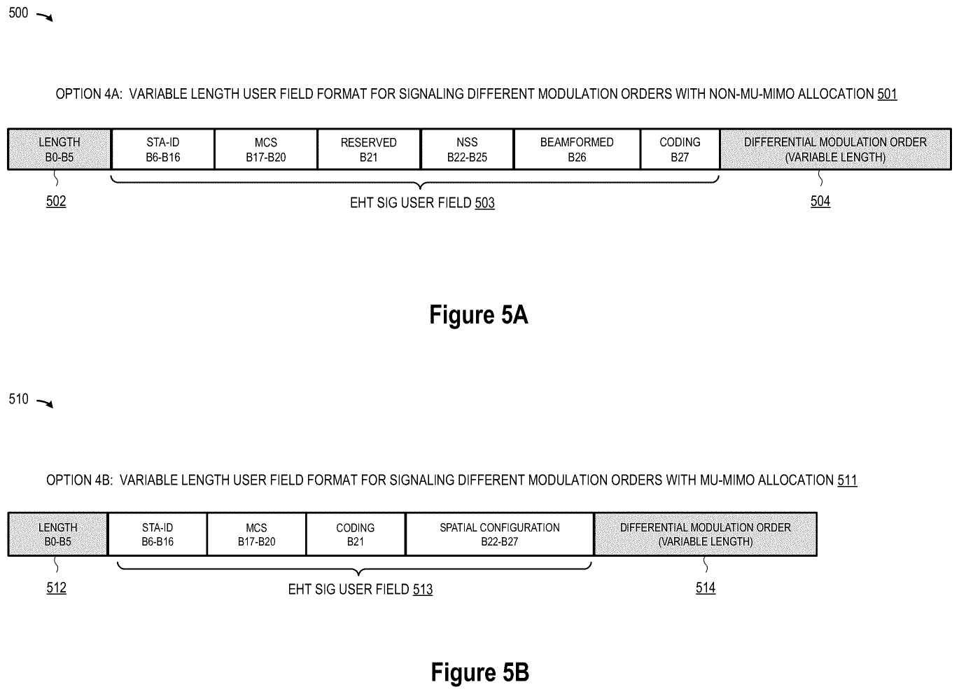

To provide additional details for an improved understanding of selected embodiments of the present disclosure, reference is now made to FIG. 5A which illustrates a New SIG User Info field 500 (option 4A) having a variable length user field format 501 for signaling differential modulation order values for non-TB transmission with non-MU-MIMO allocations. As depicted, the New SIG User Info field 500 includes a Length subfield 502 (bit positions B0-B5), an EHT-SIG user field 503 (bit positions B6-B27), and a variable length Differential Modulation Order subfield 504. The EHT-SIG user field 503 specifies a base MCS (indicating the modulation order) with the MCS subfield (bit positions B17-B20) (for example, the MCS for the first spatial stream (nₛₛ=1)), and the Differential Modulation Order subfield 504 specifies the differential modulation order for each spatial stream pair, for example, the Differential Modulation Order subfield 504 is encoded as the modulation order difference of each neighboring spatial stream. In selected embodiments, a 2-bit differential modulation order signal value specifies the difference between modulation order values of neighboring spatial streams, where value 0 indicates that same modulation order is applied to the neighboring spatial streams pair, and values 1-3 respectively indicate the modulation order applied to the spatial stream is one, two or three orders lower than the one applied to the preceding stream. Even for MIMO channels with large condition numbers, a 2-bit differential modulation order signal value can sufficiently capture the neighboring spatial subchannels differences. For example, the number of bits included in the New SIG User Info field 500 can vary from 22 (when equal modulation is used for multiple streams) to 22+(Nₛₛ−1)*2 (when unequal modulation and 2-bit differential modulation order is used). With up to 8 spatial streams, the number of bits in the New SIG User Info field 500 (excluding Length field) expands up to 36 bits. In another embodiments, a 1-bit differential modulation order signal value specifies the difference between modulation order values, where value 0 indicates that same modulation order is applied to the neighboring spatial streams pair, and value 1 indicates the modulation order applied to the spatial stream is one order lower than the one applied to the preceding stream. While the 1-bit differential modulation order signaling option may not be able to capture all the neighboring spatial subchannel differences, it is a good tradeoff between signaling overhead and performance improvement. The number of bits included in the New SIG User Info field 500 can vary from 22 (when equal modulation is used for multiple streams) to 22+(Nₛₛ−1) (when unequal modulation and 1-bit differential modulation order is used). With up to 8 spatial streams, the number of bits in the New SIG User Info field 520 (excluding Length field) expands up to 29 bits. In the indicated signaling option 4A, the number of bits varies with the number of spatial streams, Nss, and must be signaled to the receiver STA with the Length subfield 502 that is added at the beginning of each New SIG User Info field 500 to indicate the total number of bits of the remaining subfields of the New SIG User Info field 500.

To provide additional details for an improved understanding of selected embodiments of the present disclosure, reference is now made to FIG. 5B which illustrates a New SIG User Info field 510 (option 4B) having a variable length user field format 511 for signaling differential modulation order values for DL transmission with MU-MIMO allocations. As depicted, the New SIG User Info field 510 includes a Length subfield 512 (bit positions B0-B5), an EHT-SIG user field 513 (bit positions B6-B27), and a variable length Differential Modulation Order subfield 514 for specifying differential modulation order values being applied to each spatial streams pair. In selected embodiments, a 2-bit differential modulation order signal value specifies the difference between modulation order values of neighboring spatial streams. The EHT-SIG user field 513 specifies a base MCS (indicating the modulation order) with the MCS subfield (bit positions B17-B20) (for example, the MCS for the first spatial stream ((nₛₛ=1)), and the Differential Modulation Order subfield 514 includes differential modulation order values that are used for encoding each additional spatial stream nₛₛ=2, . . . , Nₛₛ if at least one of the spatial streams is assigned to a modulation order value different from the base MCS. In the indicated signaling option 4B, the number of bits varies with the number of spatial streams, Nss, and must be signaled to the receiver STA with the Length subfield 512 that is added at the beginning of each New SIG User Info field 510 to indicate the total number of bits of the remaining subfields of the New SIG User Info field 510.

As disclosed herein, applying different MCS values or modulation orders to different spatial streams based on channel conditions provides the most benefits when the beamforming transmission is full rank (i.e., the number of spatial streams equals the number of receive antenna), especially when the number of transmit antenna is also equal to number of spatial streams. However, it is common to have more antennas at the AP side than on the non-AP STA side. In addition, commercially available non-AP STAs are usually equipped with 2 antennas, and some high-end non-AP STAs may be equipped with 4 antennas. Therefore, the total number of spatial streams of the beamformed transmission is usually up to 2. In cases where there are more than 2 spatial streams, the first set of spatial streams (first spatial streams group) can be assigned to the one rate or modulation order, and the rest of the spatial streams (second spatial streams group) can be assigned to another rate table or modulation order table based on channel statistics analysis with small performance loss.

Based on this grouping of spatial streams, each of the above-described signaling options 1A-B, 2A-B, 3A-B, 4A-B (described with reference to FIGS. 2-5) needs only one index from a predefined table to indicate the MCS or modulation order for the second spatial streams group, in which case the number of bits for each New SIG User Info field is a constant number. For example, if the number of spatial streams Nₛₛ=1, then each of the 4-bit Additional MCS subfields 204, 214 (described in FIGS. 2A-B), the 3-bit (or 2-bit) Differential MCS subfields 304, 314 (described in FIGS. 3A-B), the 3-bit Modulation Order subfields 404, 414 (described in FIGS. 4A-B), the 2-bit or 1-bit Differential Modulation Order subfields 504, 514 (described in FIGS. 5A-B) are set to 0, respectively.

In addition, if number of spatial streams Nₛₛ=2, then the 4-bit Additional MCS subfields 204, 214 (described in FIGS. 2A-B) indicates the MCS value applied to second spatial stream. In addition, the 3-bit (or 2-bit) Differential MCS subfields 304, 314 (described in FIGS. 3A-B) indicate the differential MCS of the two spatial streams. In addition, the 3-bit Modulation Order subfields 404, 414 (described in FIGS. 4A-B) indicate the modulation order applied to second spatial stream. In addition, the 2-bit or 1-bit Differential Modulation Order subfields 504, 514 (described in FIGS. 5A-B) indicate the differential modulation orders of the two spatial streams.

If a non-AP STA (e.g., 21) is equipped with 4 antennas and there are three or more spatial streams (e.g., Nₛₛ>2), the first two spatial streams may be grouped and assigned with one MCS or modulation order, and the rest spatial streams are assigned with another MCS or modulation order. In this case, the first MCS subfield (original MCS) is applied to the first two spatial streams, and the 4-bit Additional MCS subfields 204, 214 (described in FIGS. 2A-B) indicates the MCS applied to the second spatial streams group. In addition, the 3-bit (or 2-bit) Differential MCS subfields 304, 314 (described in FIGS. 3A-B) indicate the differential MCS of the two spatial streams groups. In addition, the 3-bit Modulation Order subfields 404, 414 (described in FIGS. 4A-B) indicate the modulation order applied to a second spatial streams group. In addition, the 2-bit or 1-bit Differential Modulation Order subfields 504, 514 (described in FIGS. 5A-B) indicate the differential modulation orders of the two spatial stream groups indicate the differential modulation orders of the two spatial stream groups.

In comparison to the variable length signaling schemes described in FIGS. 2-5, a fixed length signaling scheme reduces signaling overhead significantly while still capturing most of the gain from link adaptation based on channel conditions. For example, even for Nₛₛ=2 case, the variable length scheme requires 6 or 5 more bits than a fixed length scheme to signal the Length field. There are up to 144 non-AP STAs can be scheduled in a 320,MHz OFDMA PPDU transmission, which amounts to 6×144=864 or 5×144=720 extra bits are used in variable length scheme. This means an extra 17 or 14 OFDM symbols (68 μs or 56airtime) are needed for those bits.

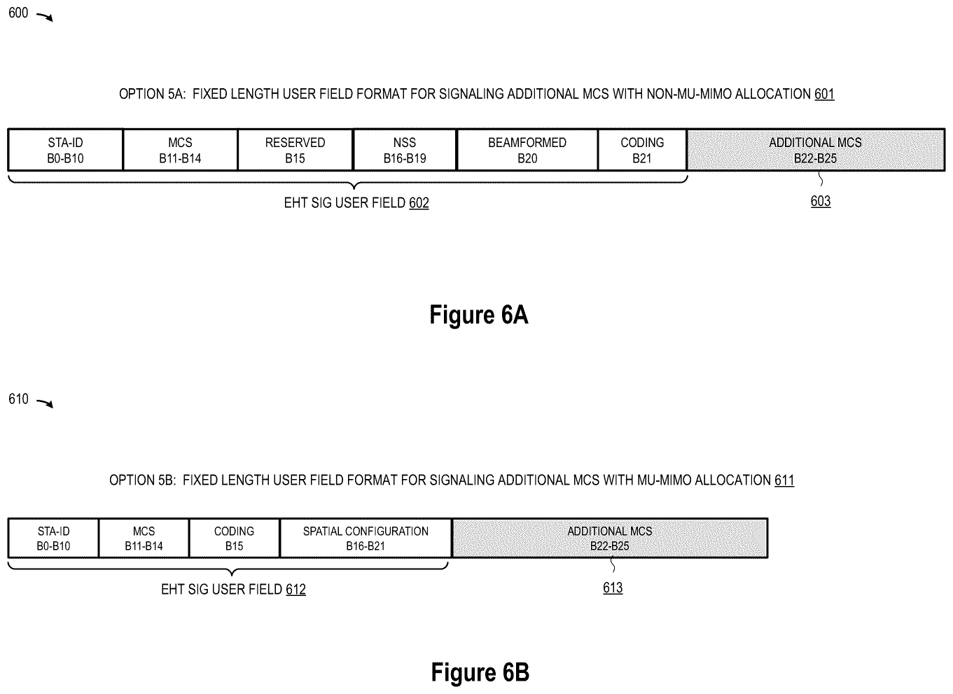

To provide additional details for an improved understanding of selected embodiments of the present disclosure, reference is now made to FIG. 6A which illustrates a New SIG User Info field 600 (option 5A) having a fixed length user field format 601 for signaling additional MCS encoding values used to encode different spatial streams for Non-TB transmission with non-MU-MIMO allocations. As depicted, the New SIG User Info field 600 includes an EHT-SIG user field 602 (bit positions B0-B21), and a fixed length Additional MCS subfield 603 (bit positions B22-B25) for specifying additional MCS values being applied to encode multiple spatial streams for Non-TB transmission. The EHT-SIG user field 602 specifies a base MCS value with the MCS subfield (bit positions B11-B14) (for example, the MCS for the first spatial stream group), and the Additional MCS subfield 603 includes additional MCS values that are used for encoding the second spatial stream group. In the indicated signaling option 5A, the New SIG User Info field 600 specifies or signals the MCS value for the second spatial stream group with a 4-bit Additional MCS subfield 603, so the number of bits included in the New SIG User Info field 600 is fixed and there is no requirement for a Length subfield being added at the beginning of the New SIG User Info field 600.

To provide additional details for an improved understanding of selected embodiments of the present disclosure, reference is now made to FIG. 6B which illustrates a New SIG User Info field 610 (option 5B) having a fixed length user field format 611 for signaling additional MCS encoding values used to encode different spatial streams for DL transmission with MU-MIMO allocations. As depicted, the New SIG User Info field 610 includes an EHT-SIG user field 612 (bit positions B0-B21), and a fixed length Additional MCS subfield 613 (bit positions B22-B25). The EHT-SIG user field 612 specifies the MCS value for the first spatial stream group with the MCS subfield (bit positions B11-B14), and the Additional MCS subfield 613 includes additional MCS values that are used for encoding the second spatial stream group with 4-bit Additional MCS values, so the number of bits included in the New SIG User Info field 610 is fixed and there is no requirement for a Length subfield being added at the beginning of the New SIG User Info field 610.

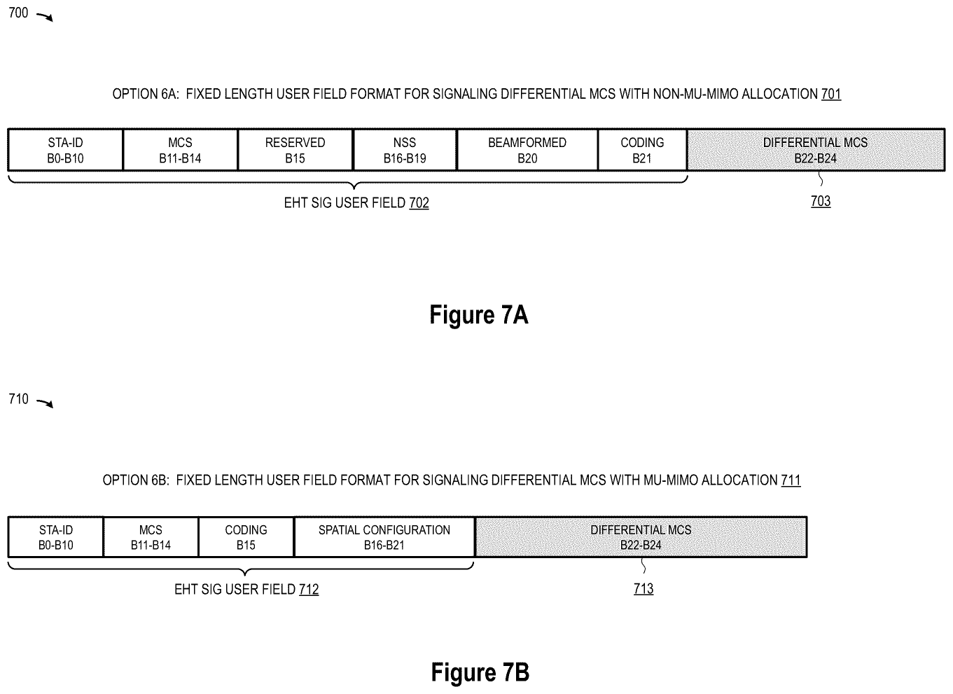

To provide additional details for an improved understanding of selected embodiments of the present disclosure, reference is now made to FIG. 7A which illustrates a New SIG User Info field 700 (option 6A) having a fixed length user field format 701 for signaling differential MCS values between neighboring spatial stream groups for Non-TB transmission with non-MU-MIMO allocations. As depicted, the New SIG User Info field 700 includes an EHT-SIG user field 702 (bit positions B0-B21) and a fixed length Differential MCS subfield 703 (bit positions B22-B24) for specifying differential MCS values being applied to encode multiple spatial streams. In the indicated signaling option 6A, a 3-bit field is used for Differential MCS subfield 703. In another embodiment, a 2-bit field may be used for Differential MCS subfield 703. The number of bits included in the New SIG User Info field 700 is fixed.

To provide additional details for an improved understanding of selected embodiments of the present disclosure, reference is now made to FIG. 7B which illustrates a New SIG User Info field 710 (option 6B) having a fixed length user field format 711 for signaling differential MCS encoding values used to encode different spatial streams for DL transmission with non-MU-MIMO allocations. As depicted, the New SIG User Info field 710 includes an EHT-SIG user field 712 (bit positions B0-B21), and a fixed length Differential MCS subfield 713 (bit positions B22-B24). The Differential MCS subfield 713 includes 3-bit differential MCS values that are used for encoding the second spatial stream group. In another embodiment, 2-bit differential MCS values can be used. The number of bits included in the New SIG User Info field 710 is fixed.

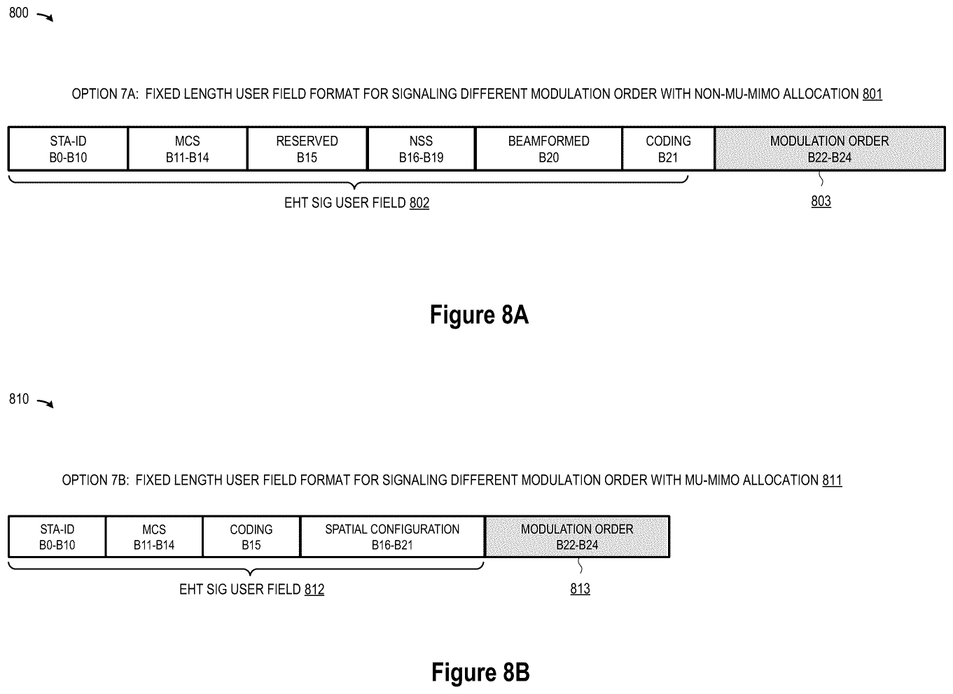

To provide additional details for an improved understanding of selected embodiments of the present disclosure, reference is now made to FIG. 8A which illustrates a New SIG User Info field 800 (option 7A) having a fixed length user field format 801 for signaling different modulation orders used to encode neighboring spatial stream groups for Non-TB transmission with non-MU-MIMO allocations. As depicted, the New SIG User Info field 800 includes an EHT-SIG user field 802 (bit positions B0-B21) and a fixed length Modulation Order subfield 803 (bit positions B22-B24) for specifying different modulation orders being applied to encode multiple spatial streams for Non-TB transmission. In one embodiment, the Modulation Order subfield 803 includes 3-bit modulation order values that are used for encoding the second spatial stream group. The number of bits included in the New SIG User Info field 800 is fixed.

To provide additional details for an improved understanding of selected embodiments of the present disclosure, reference is now made to FIG. 8B which illustrates a New SIG User Info field 810 (option 7B) having a fixed length user field format 811 for signaling different modulation orders used to encode different spatial streams for DL transmission with MU-MIMO allocations. As depicted, the New SIG User Info field 810 includes an EHT-SIG user field 812 (bit positions B0-B21), and a fixed length Modulation Order subfield 813 (bit positions B22-B24). In one embodiment, the Modulation Order subfield 813 includes 3-bit modulation order values that are used for encoding the second spatial stream group. The number of bits included in the New SIG User Info field 810 is fixed.

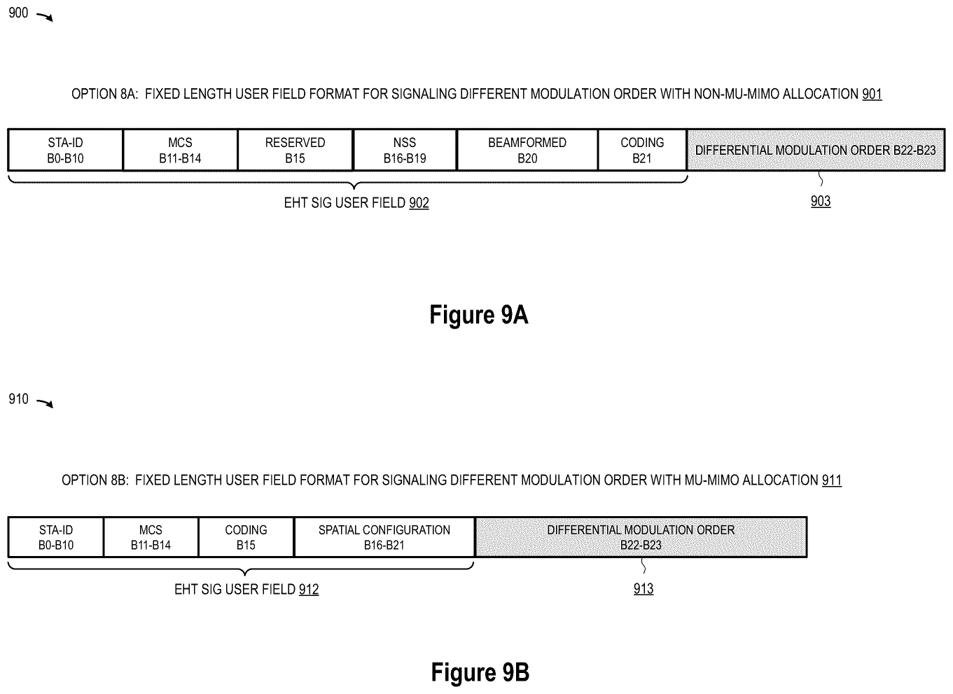

To provide additional details for an improved understanding of selected embodiments of the present disclosure, reference is now made to FIG. 9A which illustrates a New SIG User Info field 900 (option 8A) having a fixed length user field format 901 for signaling differential modulation order for the second spatial stream groups for Non-TB transmission with non-MU-MIMO allocations. As depicted, the New SIG User Info field 900 includes an EHT-SIG user field 902 (bit positions B0-B21) and a fixed length Differential Modulation Order subfield 903 (bit positions B22-B23) for specifying differential modulation order values being applied to encode multiple spatial streams for Non-TB transmission. In one embodiment, the Differential Modulation Order subfield 903 includes 2-bit differential modulation order values that are used for encoding the second spatial stream group. In another embodiment, the Differential Modulation Order subfield 903 includes 1-bit differential modulation order value. The number of bits included in the New SIG User Info field 900 is fixed

To provide additional details for an improved understanding of selected embodiments of the present disclosure, reference is now made to FIG. 9B which illustrates a New SIG User Info field 910 (option 8B) having a fixed length user field format 911 for signaling differential modulation order encoding values used to encode different spatial streams for DL transmission with MU-MIMO allocations. As depicted, the New SIG User Info field 910 includes an EHT-SIG user field 912 (bit positions B0-B21), and a fixed length Differential Modulation Order subfield 913 (bit positions B22-B23). In one embodiment, the Differential Modulation Order subfield 913 includes 2-bit differential modulation order values that are used for encoding the second spatial stream group. In another embodiment, the Differential Modulation Order subfield 913 includes 1-bit differential modulation order values. The number of bits included in the New SIG User Info field 910 is fixed.

As disclosed hereinabove, the fixed length user field formats use 2-4 additional bits to signal different MCS or modulation orders applied to the second spatial streams groups. These additional signaling bits can still require a large signaling overhead if the number of user information field is large, especially for 320 MHz OFDMA PPDU with many scheduled small RU STAS, as compared to the existing 802.11be EHT-SIG user field. In addition, the length change from EHT-SIG user information field also increases the complexity of the transmitter SIG encoder logic and receiver SIG parser logic. To eliminate this additional signaling overhead and complexity, the New SIG reuses the format of user information field as EHT-SIG without adding extra bits, and repurposes one or more subfields of the 802.11be EHT-SIG user information field to indicate the new MCSs applied to the MIMO transmission with multiple spatial streams group. One reserved bit or validate bit in the EHT-SIG user information field can be reused as “Equal MCS” bit indicating whether the same MCS is applied to all spatial streams and the meaning of other repurposed bits for new rate signaling.

For non-trigger-based transmission with a non-MU-MIMO allocation, EHT-SIG user information field has a reserved bit (bit position B15) set to 1 in the 802.11be specification. This reserved bit can be repurposed as the “Equal MCS” subfield. When the “Equal MCS” subfield is set to 0, this signals that different MCS values are applied to different spatial streams, and when the “Equal MCS” subfield is set to 1, this indicates the same MCS is applied to all spatial streams. In general, unequal MCS or modulation is mostly beneficial to beamformed transmission, and in selected embodiments, unequal MCS or modulation rates can only be allowed or defined for beamformed PPDU. In this case, bit position B20 from the 802.11be EHT-SIG user field can be repurposed to signal an unequal MCS or modulation rate signaling. Furthermore, the unequal MCS or modulation rate can be limited to small Nss values (e.g., 4 or 8), and there are 4 bits in Nss subfield of the 802.11be EHT-SIG user field. As a result, one or two bits of the Nss subfield of the 802.11be EHT-SIG user field can be repurposed. For example, if the “Equal MCS” subfield (bit position B15) is 0, the Nss subfield from the 802.11be EHT-SIG user field can be reduced to 2 bits (bit positions B16-B17). Furthermore, if the new unequal MCS or modulation rates is limited to LDPC only, Coding subfield (bit position B21) from the 802.11be EHT-SIG user field can also be reused. As a result, bits B18-B21 from the 802.11be EHT-SIG user field may be repurposed as a 4-bit subfield for unequal MCS or modulation rate signaling. For example, in option 6A, all 4-bit is interpreted as Additional MCS subfield to indicate the new MCS values applied to the second spatial streams group. For signaling option 7A (differential MCS signaling), the Coding subfield from the 802.11be EHT-SIG user field (bit position B21) is not repurposed, and bit positions B18-B20 from the 802.11be EHT-SIG user field are repurposed as a 3-bit Differential MCS subfield to indicate the differential MCS, or the Beamformed subfield (bit position B20) and the Coding subfield (bit position B21) from the 802.11be EHT-SIG user field are not repurposed, and bit positions B18-B19 from the 802.11be EHT-SIG user field are repurposed as a 2-bit Differential MCS subfield to indicate the differential MCS. Finally, if the “Equal MCS” subfield (bit position B15) is 1, the Nss subfield, Beamformed subfield, and Coding subfield from the 802.11be EHT-SIG user field are not repurposed.

For DL transmission with a MU-MIMO allocation, the 802.11be EHT-SIG user field has a coding bit (bit position B15) which shall be set to 1 with one exception that this bit can be set to 0 when allocated RU size is 242-tone. For the next generation WIFI devices, LDPC encoding can be a mandatory support for MU-MIMO transmissions. In that case, the coding bit (bit position B15) can be repurposed to provide an “Equal MCS” subfield. In particular, the “Equal MCS” subfield at bit position B15 is set to 1 to indicate that same MCS or modulation order is applied to all spatial streams, and is set to 0 to indicate that different MCS or modulation orders are applied to different spatial streams. In addition, the 4-bit Spatial configuration field from the 802.11be EHT-SIG user field with MU-MIMO allocations is sufficient to cover all configurations based on the current total number of spatial streams support up to 8. Even with forward compatibility to support total number of streams up to 16, different MCS or modulation orders can be limited to applying to spatial combinations that benefit the most, such as spatial combinations with most of the MU pairing STAs with more than 1 spatial stream. Those spatial combinations can be represented by 4 bits with the first two bits being 00 in the 6-bit spatial configuration table. If the “Equal MCS” subfield at bit position B15 is set to 0, then the two most significant bits in the Spatial configuration subfield can be repurposed as a 2-bit Differential MCS subfield or a 2-bit Differential Modulation order subfield. Alternatively, bit position B20 is reserved, and bit position B21 can be repurposed as 1-bit Differential Modulation order subfield. Finally, if the “Equal MCS/MOD” subfield (bit position B15) is 1, then the Spatial configuration subfield interpretation is the same as before. Due to the lack of bits for repurposing, signaling options 6B, 7B and 8B cannot be used in MU-MIMO transmissions.

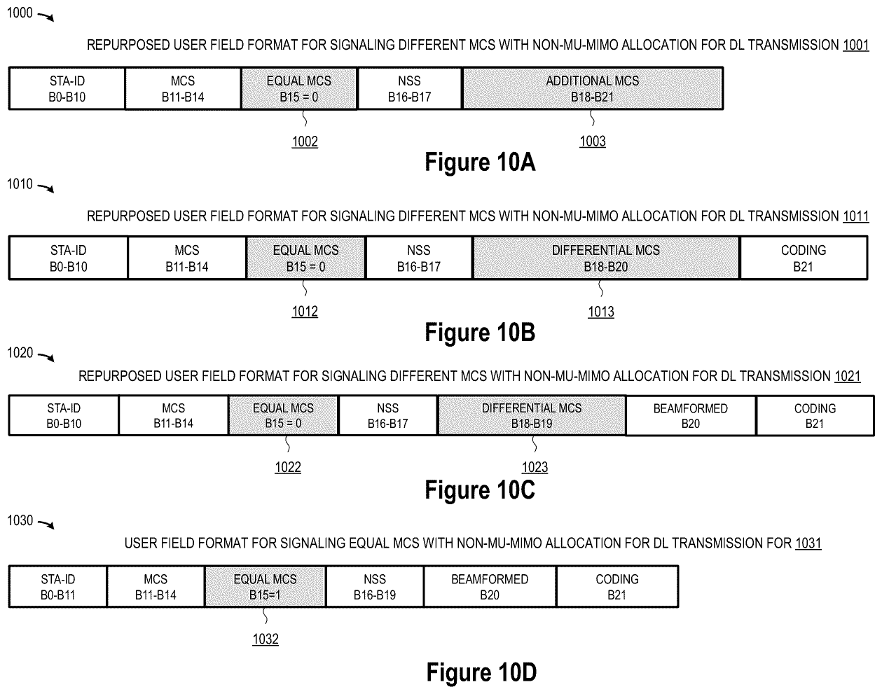

To provide additional details for an improved understanding of selected embodiments of the present disclosure, reference is now made to FIG. 10A which illustrates a New SIG User Info field 1000 having a repurposed user field format 1001 for signaling different MCS values used to encode different spatial streams for non-TB transmission with non-MU-MIMO allocations. As depicted, the New SIG User Info field 1000 includes an EHT-SIG user field (bit positions B0-B21) with an Equal MCS subfield 1002 (formed from repurposed bit position B15) set to value 0, and a fixed length Additional MCS subfield 1003 (formed from repurposed bit positions B18-B21) for specifying additional MCS values being applied to encode multiple spatial streams for non-TB transmission. The EHT-SIG user MCS subfield (bit positions B11-B14) specifies the MCS value for the first spatial stream group, and the Additional MCS subfield 1003 includes 4-bit MCS values that are used for encoding the second spatial stream group.

To provide additional details for an improved understanding of selected embodiments of the present disclosure, reference is now made to FIG. 10B which illustrates a New SIG User Info field 1010 having a repurposed user field format 1011 for signaling differential MCS values used to encode different spatial streams for Non-TB transmission with non-MU-MIMO allocations. As depicted, the New SIG User Info field 1010 includes an EHT-SIG user field (bit positions B0-B21) with an Equal MCS subfield 1012 (formed from repurposed bit position B15) set to value 0, and in one embodiment, a fixed length Differential MCS subfield 1013 (formed from repurposed bit positions B18-B20) for specifying 3-bit differential MCS values being applied to encode multiple spatial streams. The EHT-SIG user MCS subfield (bit positions B11-B14) specifies the MCS value for the first spatial stream group, the Differential MCS subfield 1013 includes 3-bit MCS values that are used for encoding the second spatial stream group.

To provide additional details for an improved understanding of selected embodiments of the present disclosure, reference is now made to FIG. 10C which illustrates a signaling SIG User Info field 1020 having a repurposed user field format 1021 for signaling 2-bit differential MCS values used to encode different spatial streams for DL transmission for non-MU-MIMO allocations. As depicted, the signaling SIG User Info field 1020 includes an SIG user field (bit positions B0-B21) with an Equal MCS subfield 1012 (formed from repurposed bit position B15) set to value 0, and a fixed length Differential MCS subfield 1013 (formed from repurposed bit positions B18-B19) for specifying 2-bit differential MCS values being applied to encode multiple spatial streams for DL transmission. Since the EHT-SIG user MCS subfield (bit positions B11-B14) specifies the MCS value for the first spatial stream group, the Differential MCS subfield 1023 includes 2-bit MCS values that are used for encoding the second spatial stream group.

To provide additional details for an improved understanding of selected embodiments of the present disclosure, reference is now made to FIG. 10D which illustrates a New SIG User Info field 1030 having a repurposed user field format 1031 for signaling equal MCS values used to encode different spatial streams for Non-TB transmission with non-MU-MIMO allocations. As depicted, the New SIG User Info field 1030 includes an EHT-SIG user field (bit positions B0-B21) with an Equal MCS subfield 1032 (formed from repurposed bit position B15) set to value 1 to indicate that the same MCS values are applied to multiple spatial streams.

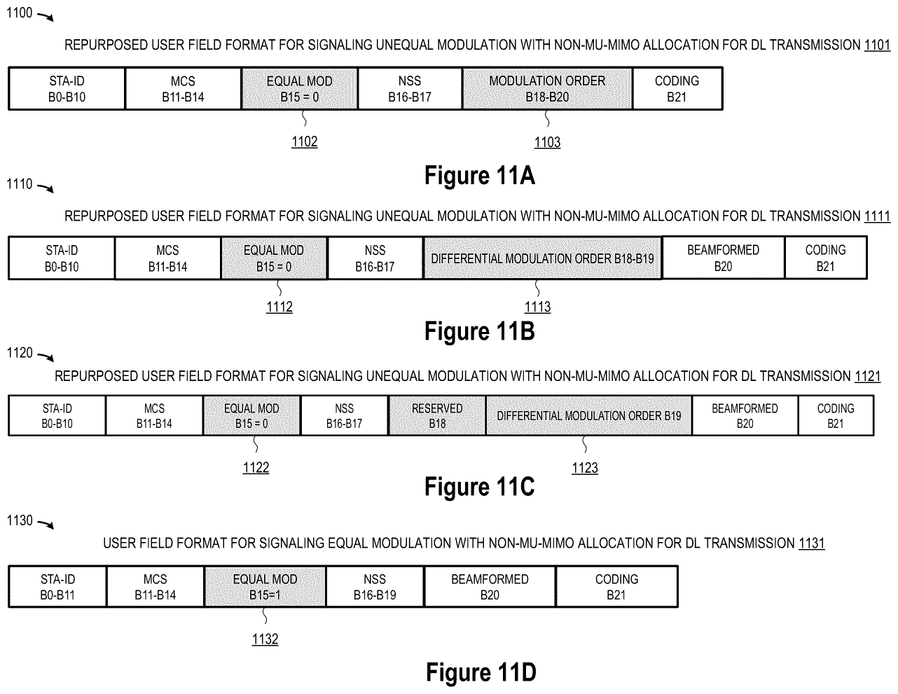

To provide additional details for an improved understanding of selected embodiments of the present disclosure, reference is now made to FIG. 11A which illustrates a New SIG User Info field 1100 having a repurposed user field format 1101 for signaling 3-bit differential modulation order values used to encode different spatial streams for Non-TB transmission with non-MU-MIMO allocations. As depicted, the New SIG User Info field 1100 includes an EHT-SIG user field (bit positions B0-B21) with an Equal MOD subfield 1102 (formed from repurposed bit position B15) set to value 0, and a fixed length Modulation Order subfield 1103 (formed from repurposed bit positions B18-B20) for specifying additional modulation order values being applied to encode multiple spatial streams. The EHT-SIG user MCS subfield (bit positions B11-B14) specifies the modulation order value for the first spatial stream group, and in selected embodiments, the Modulation Order subfield 1103 includes 3-bit modulation order values that are used for encoding the second spatial stream group.

To provide additional details for an improved understanding of selected embodiments of the present disclosure, reference is now made to FIG. 11B which illustrates a New SIG User Info field 1110 having a repurposed user field format 1111 for signaling 2-bit differential modulation order values used to encode different spatial streams for Non-TB transmission with non-MU-MIMO allocations. As depicted, the New SIG User Info field 1110 includes an EHT-SIG user field (bit positions B0-B21) with an Equal MOD subfield 1122 (formed from repurposed bit position B15) set to value 0, and a fixed length Differential Modulation subfield 1113 (formed from repurposed bit positions B18-B19) for specifying 2-bit differential modulation order values being applied to encode multiple spatial streams. The EHT-SIG user MCS subfield (bit positions B11-B14) specifies the modulation order for the first spatial stream group, and in selected embodiments, the Differential Modulation Order subfield 1113 includes 2-bit differential modulation order values that are used for encoding the second spatial stream group.

To provide additional details for an improved understanding of selected embodiments of the present disclosure, reference is now made to FIG. 11C which illustrates a New SIG User Info field 1120 having a repurposed user field format 1121 for signaling 1-bit differential modulation order values used to encode different spatial streams for Non-TB transmission with non-MU-MIMO allocations. As depicted, the New SIG User Info field 1120 includes an EHT-SIG user field (bit positions B0-B21) with an Equal MOD subfield 1122 (formed from repurposed bit position B15) set to value 0, and a fixed length Differential Modulation Order subfield 1113 (formed from repurposed bit position B19) for specifying 1-bit differential modulation order values being applied to encode multiple spatial streams. The EHT-SIG user MCS subfield (bit positions B11-B14) specifies the modulation order for the first spatial stream group, and in selected embodiments, the Differential Modulation Order subfield 1123 includes a 1-bit differential modulation order value that is used for encoding the second spatial stream group.

To provide additional details for an improved understanding of selected embodiments of the present disclosure, reference is now made to FIG. 11D which illustrates a New SIG User Info field 1130 having a repurposed user field format 1131 for signaling equal modulation order values used to encode different spatial streams for Non-TB transmission with non-MU-MIMO allocations. As depicted, the New SIG User Info field 1130 includes an EHT-SIG user field (bit positions B0-B21) with an Equal MOD subfield 1132 (formed from repurposed bit position B15) set to value 1 to indicate that the same modulation order values are applied to multiple spatial streams.

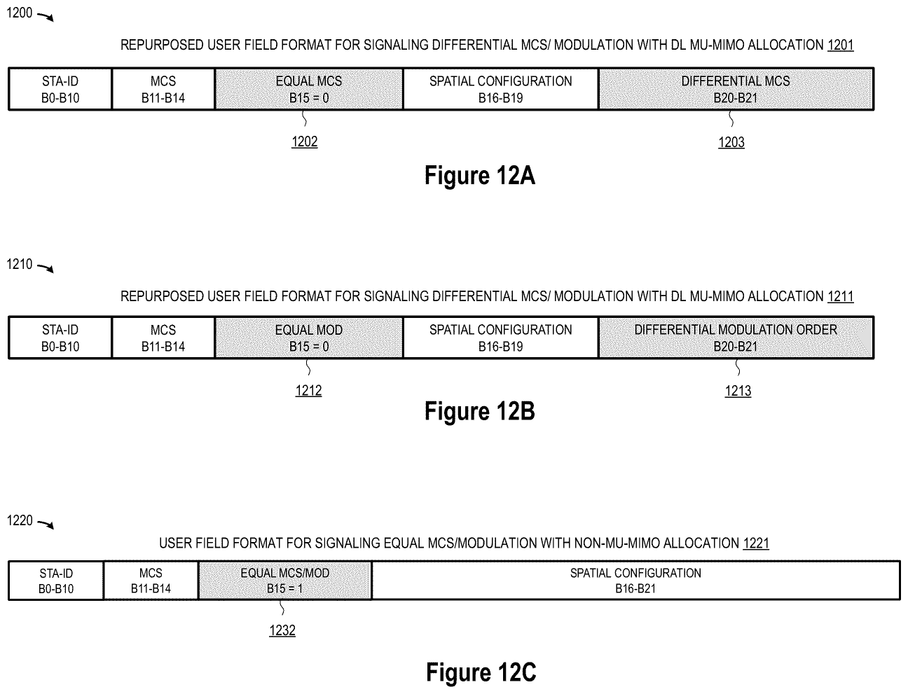

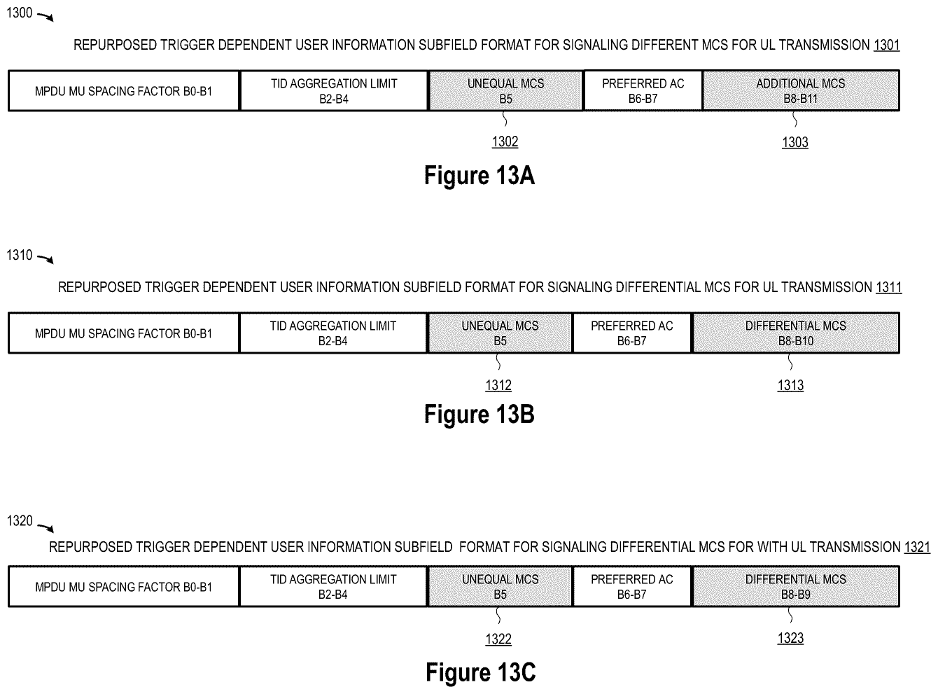

To provide additional details for an improved understanding of selected embodiments of the present disclosure, reference is now made to FIG. 12A which illustrates a New SIG User Info field 1200 having a repurposed user field format 1201 for signaling differential MCS values used to encode different spatial streams for DL transmission with MU-MIMO allocations. As depicted, the New SIG User Info field 1200 includes an EHT-SIG user field (bit positions B0-B21) with an Equal MCS subfield 1202 (formed from repurposed coding bit position B15) set to value 0, and a fixed length Differential MCS subfield 1203 (formed from repurposed bit positions B20-B21) for specifying 2-bit differential MCS values being applied to encode multiple spatial streams. The EHT-SIG user MCS subfield (bit positions B11-B14) specifies the MCS value for the first spatial stream group, and the Differential MCS subfield 1203 includes 2-bit MCS configuration that are used for encoding the second spatial stream group.

To provide additional details for an improved understanding of selected embodiments of the present disclosure, reference is now made to FIG. 12B which illustrates a New SIG User Info field 1210 having a repurposed user field format 1211 for signaling 2-bit differential modulation order values used to encode different spatial streams for DL transmission with MU-MIMO allocations. As depicted, the New SIG User Info field 1210 includes an EHT-SIG user field (bit positions B0-B21) with an Equal MOD subfield 1212 (formed from repurposed bit position B15) set to value 0, and a fixed length Differential Modulation Order subfield 1213 (formed from repurposed bit positions B20-B21) for specifying 2-bit differential modulation order values being applied to encode multiple spatial streams. The EHT-SIG user MCS subfield (bit positions B11-B14) specifies the modulation order for the first spatial stream group, and in one embodiment, the Differential Modulation Order subfield 1213 includes 2-bit differential modulation order configuration that are used for encoding the second spatial stream group. In another embodiment, the Differential Modulation Order subfield 1213 includes a 1-bit differential modulation order value that is used for encoding the second spatial stream group.

To provide additional details for an improved understanding of selected embodiments of the present disclosure, reference is now made to FIG. 12C which illustrates a New SIG User Info field 1220 having a repurposed user field format 1221 for signaling equal MCS/modulation order values used to encode different spatial streams for DL transmission with MU-MIMO allocations. As depicted, the New SIG User Info field 1220 includes an EHT-SIG user field (bit positions B0-B21) with an Equal MCS/MOD subfield 1222 (formed from repurposed bit position B15) set to value 1 to indicate that the same MCS and modulation order values are applied to multiple spatial streams.

In accordance with other selected embodiments of the present disclosure, there is disclosed a system, apparatus, and methodology for selecting unequal modulation MCS for next generation WIFI based on channel condition number statistics, or SNR gaps between different spatial streams which can be obtained from 1) per spatial stream SNR feedback in a beamforming report, or 2) receiver feedback of preference of equal or unequal modulations. In order to signal the use of unequal MCS values and/or modulation orders to one or more receiving STA devices, a single designated bit in a New SIG user info field or Trigger frame user info field is used to signal whether equal or unequal modulations are applied to different spatial streams for DL or UL transmission. In addition to the 1-bit unequal modulations signaling, one unique MCS table is proposed for signaling unequal modulation for each number of spatial streams. By limiting the unequal modulation table to 16 entries, the current 4-bit MCS subfield in a user info field can be repurposed to indicate unequal modulations combination without adding any extra signaling overhead.

Although selected embodiments of the present disclosure propose unequal modulations for up to 4 spatial streams by providing different MCS tables, the disclosed proposal differs from the 802.11n approach by which support the number of QAM orders to include 64QAM through 4096QAM (3 more higher order QAMs are added). In addition, the present disclosure uses different MCS labeling than the 802.11n style which requires 7 bits to signal both equal, unequal modulation MCS and Nsts, whereas the present disclosure uses the same number of bits to signal unequal modulation MCS as equal modulation MCS. In addition, separate Nss bits are used to signal the number of spatial streams with each Nss value pointing to a corresponding MCS table. Furthermore, the new MCS signaling bits are part of a user information field, which enables the MCS signaling for multi-user case, which is not defined in the IEEE 802.11n standard. To this end, one designated bit in SIG user info field/Trigger frame user info field indicates whether an equal modulation MCS table or unequal modulation MCS table is applied to data field modulation.

To facilitate easier rate adaptation leveraging the CQI feedback, different MCS values can be applied to different spatial streams which use different coding rates for different spatial streams.

In the present disclosure, new unequal modulation MCS tables are defined for different number of spatial streams without adding any extra signaling overhead compared to the current standard MCS signaling field. Each unequal modulation MCS table provides more useful and finer rate granularity than the current MCS table for given spatial streams.

The following operations are described with the assumption that a transmitter supports unequal modulation for different spatial streams transmission, and that a receiver supports unequal modulation for different spatial streams reception. This information can be exchanged during association process via management frames. Hardware can support unequal modulations for different spatial streams with minimum changes if signaling unequal modulation and the corresponding MCS tables are adopted in the standard specification.

In operation, a receiver can request the transmitter to apply unequal modulation for different spatial streams if the averaged channel condition number is above some threshold

$$( e . g , \frac{{λ}_{1}}{{λ}_{2}} \geq 2 )$$

or if the per stream SNR difference between different spatial streams is above some threshold (e.g., 5 dB). The receiver can further recommend the modulation difference between different spatial streams based on the value of average channel condition number, or per stream SNR difference between different spatial streams.

For transmission, the transmitter can choose unequal transmission based on per stream SNR feedback in a beamforming feedback report if the receiver supports unequal modulation reception, even if the receiver does not request unequal modulation transmission or feedback its preference between equal or unequal modulation.

As indicated above, the optional feature of using unequal modulations for different spatial streams in transmission was adopted in IEEE 802.11n, but is no longer adopted in the later standards, such as IEEE 802.11ac, 802.11ax and 802.11be. Using an equal rate for different spatial streams when channel has large condition number is not optimal in term of capacity. To have error free or tolerable error level transmission while maximizing throughput, stronger spatial streams most likely operate at lower rates which the corresponding spatial subchannels can support, and weaker spatial streams most likely operate at higher rate which the corresponding spatial subchannels can support. The final PER performance and throughput are bottlenecked by the weaker streams.

Although using different rates for different spatial streams can maximize the performance gain, it requires significant PHY and MAC changes. PHY changes include at least separate encoding/decoding per spatial stream, MAC changes include at least separate AMPDU/PSDU and BA for each spatial stream. In contrast, the present disclosure's proposal to provide unequal modulation without changing code rate per stream requires minor standard spec changes, minimum PHY changes, and no MAC changes. It can be easily adopted in next generation WIFI to improve system performance such as throughput and latency.

As disclosed hereinabove and illustrated in FIGS. 2-13, unequal modulation signaling schemes with different options are proposed to include possible modulation combinations among different spatial streams. While some of the signaling options are very flexible in modulation order combinations for different spatial streams, other signaling options are imposed with some restrictions in modulation order combinations for different spatial streams to reduce signaling overhead. In addition, it is not always intuitive for the transmitter to choose the specific modulation combination for the transmission among the different signaling options. The signaling options requiring the smallest overhead require that other signal fields be repurposed, which may result in some complexities in decoding signaling information.

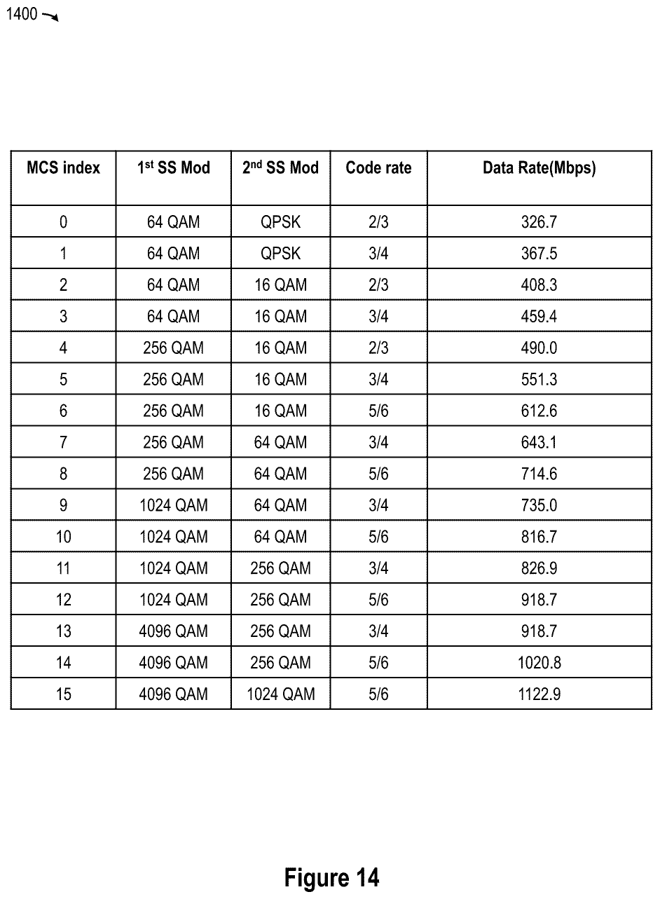

Based on exhaustive simulations of PER and RvR results, selected embodiments of the present disclosure proposes three unequal MCS tables depicted at FIGS. 14-16 which include modulation combinations contributing to performance gain for Nss=2, 3, 4 since these three Nss values are most used for transmissions to one receiver.

In order to signal unequal modulation for DL/UL transmissions, the AP and STA can, during association, exchange unequal modulation for different spatial stream transmit and receive support.

In particular, an STA supporting unequal modulation reception can assist AP to select between equal and unequal modulation for transmission, such as by reporting a preference of equal modulation or unequal modulation based on the channel condition number statistics. If the STA does not feedback the preference, the AP can use current beamforming per stream SNR feedback as an indication to choose unequal modulation MCS if the SNR difference between any two of the spatial streams is greater than some threshold, e.g., 5 dB.

Unequal modulation applied to different spatial streams can potentially benefit multi-stream UL transmissions when the STA applies implicit beamforming. If explicit beamforming for UL MU transmission is adopted in WiFi standard such as UHR, then beamformed multi-stream UL transmission can benefit more from unequal modulation from sounding feedback.

AP uses UL channel condition number statistics to select equal or unequal modulation for UL TB PPDU if triggered STA supports unequal modulation transmission and beamforming.

For non-TB transmission, a 1-bit “unequal_modulation_MCS” subfield may be defined in each SIG user info field. When the “unequal_modulation_MCS” subfield is set to 0, this indicates an equal modulation MCS table is applied to the following data field. However, when the “unequal_modulation_MCS” subfield is set to 1, this indicates an unequal modulation MCS table is applied to the following data field. Alternatively, a 1-bit “equal_modulation MCS” subfield is defined in each SIG user info field, where the “equal_modulation_MCS” subfield is set to 0 to indicate that an unequal modulation MCS table is applied to the following data field, and is set to 1 to indicate that an equal modulation MCS table is applied to the following data field. For example, the reserved bit (bit position B15) in EHT-SIG user info field for a non-MU-MIMO allocation can be defined as the “unequal_modulation_MCS” subfield or the “equal_modulation_MCS” subfield if the UHR SIG user info field uses the same format as EHT SIG user info field.

For UL TB transmission, a 1-bit“unequal_modulation_MCS” subfield may be defined in each Trigger frame user info field. When the “unequal_modulation_MCS” subfield is set to 0, this indicates an equal modulation MCS table is applied to the solicited UL TB PPDU data field. However, when the “unequal_modulation_MCS” subfield is set to 1, this indicates an unequal modulation MCS table is applied to the solicited UL TB PPDU data field. Alternatively, a 1-bit “equal_modulation_MCS” subfield is defined in each Trigger frame user info field, where the “equal_modulation_MCS” subfield is set to 0 to indicate that an unequal modulation MCS table is applied to the solicited UL TB PPDU data field, and is set to 1 to indicate that an equal modulation MCS table is applied to the solicited UL TB PPDU data field. For example, the reserved bit (bit position B25) in the Trigger frame user info field can be defined as the “unequal_modulation_MCS” subfield or the “equal_modulation_MCS” subfield if the UHR Trigger frame user info field uses the same format as EHT Trigger frame user info field.

For DL and UL transmissions, if the equal modulation MCS is indicated by the 1-bit “unequal_modulation_MCS” subfield or the “equal_modulation_MCS” subfield, the equal MCS table is used as in current standard. However, if the unequal modulation MCS is indicated by the 1-bit “unequal_modulation_MCS” subfield or the “equal_modulation_MCS” subfield, for a given number of transmitted spatial stream Nss, 4 bits MCS field (0-15) will be mapped to a unique modulation combination and code rate as shown in the corresponding MCS table.

In accordance with selected embodiments of the present disclosure, there is disclosed a system, apparatus, and methodology for selecting equal modulation or unequal modulations for different spatial streams in a beamformed multi-stream MIMO transmission for each scheduled user of the DL or UL transmissions based on channel statistics. In operation, the receiver may feed back the preference of equal modulation or unequal modulations for different spatial streams to the transmitter based on channel statistics. If channel condition number or per spatial stream SNR value differences are above some threshold, receiver may feed back the preference of unequal modulations for different spatial streams to the transmitter, and may otherwise feed back the preference of equal modulation for different spatial streams to the transmitter.

At the transmitter side, the transmitter may select equal modulation or unequal modulations for different spatial streams based on per stream SNR value feedback in beamforming compressed feedback report. If the “per spatial stream SNR value” differences are above a specified threshold, the transmitter may select unequal modulations for different spatial streams for transmission, and if the “per spatial stream SNR value” differences are not above the specified threshold, the transmitter may select equal modulation for different spatial streams for transmission.

In selected embodiments, an AP receiver selects equal modulation or unequal modulations for different spatial streams to the transmitter (non-AP STA) based on channel statistics for triggered UL transmission. If the channel condition number or per spatial stream SNR value differences are above a specified threshold, the receiver selects unequal modulations for different spatial streams and sends the information to the transmitter in trigger frame. However, if the channel condition number or per spatial stream SNR value differences are not above the specified threshold, the receiver may select equal modulation for different spatial streams and send the information to the transmitter in trigger frame.

In order to signal whether equal modulation or unequal modulations are used for different spatial streams in a beamformed multi-stream MIMO transmission for each scheduled user of the DL or UL transmissions, a single designated bit in the SIG user info field may be used to indicate that a value in MCS subfield is mapped to an equal modulation MCS value or is mapped to a unique unequal modulation order combinations for transmitted spatial stream Nₛₛ=2,3, 4, for each scheduled user for DL transmission. In addition or in the alternative, a single designated bit in the Trigger frame user info field may be used to indicate that a value in MCS subfield is mapped to an equal modulation MCS value or is mapped to a unique unequal modulation order combinations for transmitted spatial stream Nₛₛ=2, 3, 4 for each scheduled user for UL transmission.

In other embodiments, there is disclosed a method of signaling different modulation orders for different spatial streams in a multi-stream beamformed MIMO transmission for each scheduled user in DL and UL transmissions. In selected embodiments, a 4-bit MCS value for each unique modulation order combinations for spatial stream N=2,3,4 is signaled in the SIG user info field for each scheduled user in DL transmission. In other embodiments, a 4-bit MCS value for each unique modulation order combinations for spatial stream Nₛₛ=2,3,4 is signaled in the Trigger frame user info field for each scheduled user in UL transmission. As disclosed herein, each 4-bit MCS value may be mapped to specific modulation combinations for nₛₛ=1, . . . , Nₛₛ as shown, respectively, in the unequal modulation MCS tables 1400, 1500, 1600 for transmitted spatial stream values Nₛₛ=2, 3, 4.

In particular and with reference to FIG. 14, when using unequal modulations with two transmitted spatial stream values Nₛₛ=2, each 4-bit MCS value may be mapped to the specific modulation combinations shown in the unequal modulation MCS table 1400. As depicted, the table 1400 has 16 entries with unequal modulation MCS values listed at each entry which is accessed by an MCS index value. In particular, the unequal modulation MCS table 1400 includes MCS index values (e.g., MCS Index=1) for accessing entries which list specific combinations of unequal modulation MCS values (e.g., 64 QAM for the first spatial stream and QPSK for the second spatial stream) for encoding two transmitted spatial streams at the same code rate (e.g., ¾) and data rate (e.g., 367.5 Mbsp).

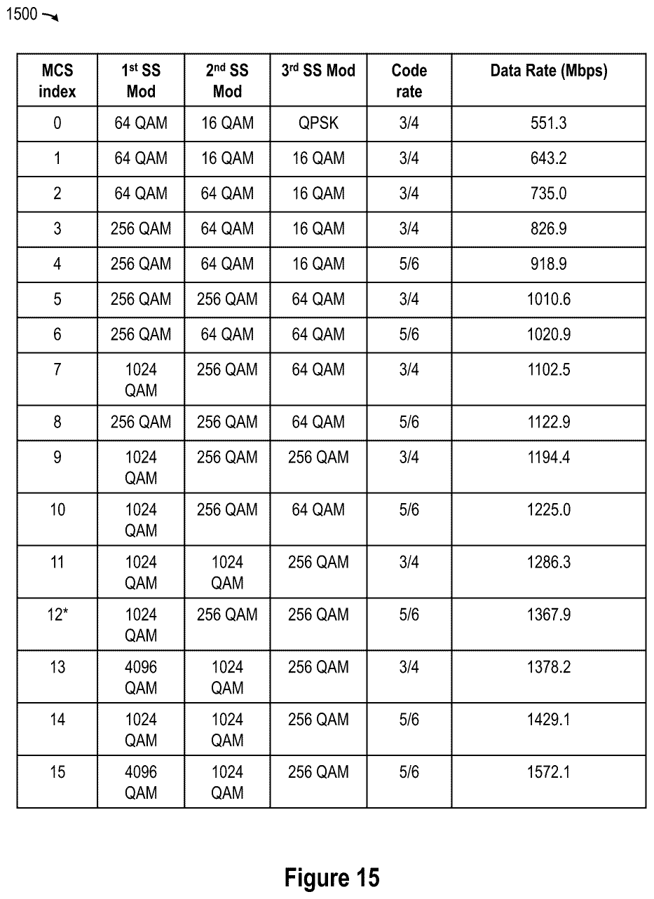

In addition and with reference to FIG. 15, when using unequal modulations with three transmitted spatial stream values Nₛₛ=3, each 4-bit MCS value may be mapped to the specific modulation combinations shown in the unequal modulation MCS table 1500. As depicted, the table 1500 has 16 entries with unequal modulation MCS values listed at each entry which is accessed by an MCS index value. In particular, the unequal modulation MCS table 1500 includes MCS index values (e.g., MCS Index=1) for accessing entries which list specific combinations of unequal modulation MCS values (e.g., 64 QAM for the first spatial stream, 16 QAM for the second spatial stream, and 16 QAM for the third spatial stream) for encoding three transmitted spatial streams at the same code rate (e.g., ¾) and data rate (e.g., 643.2 Mbsp).

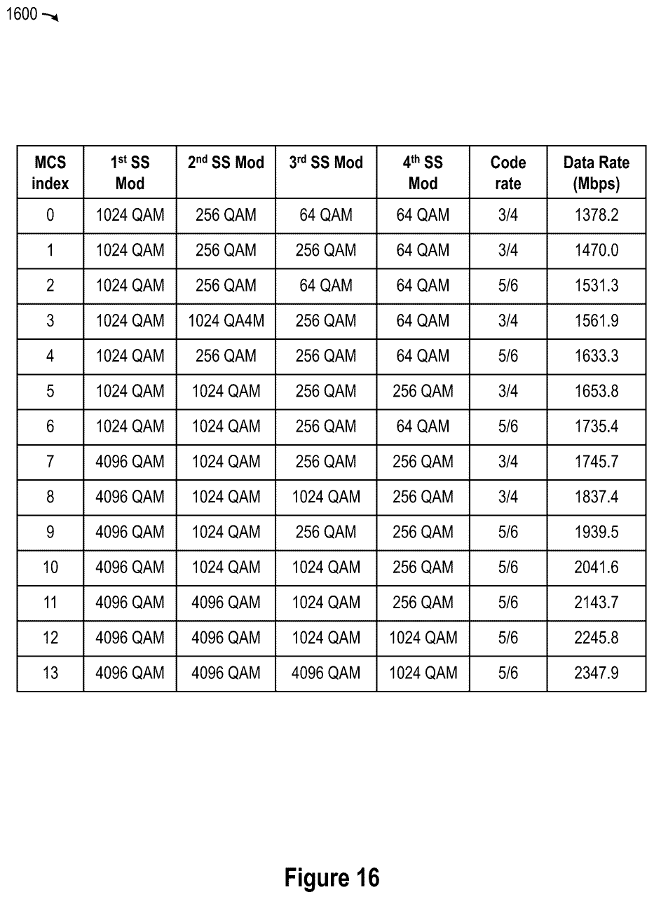

In addition and with reference to FIG. 16, when using unequal modulations with four transmitted spatial stream values Nₛₛ=4, each 4-bit MCS value may be mapped to the specific modulation combinations shown in the unequal modulation MCS table 1600. As depicted, the table 1600 has 14 entries with unequal modulation MCS values listed at each entry which is accessed by an MCS index value. In particular, the unequal modulation MCS table 1600 includes MCS index values (e.g., MCS Index=1) for accessing entries which list specific combinations of unequal modulation MCS values (e.g., 1024 QAM for the first spatial stream, 256 QAM for the second spatial stream, 256 QAM for the third spatial stream, and 64 QAM for the fourth spatial stream) for encoding four transmitted spatial streams at the same code rate (e.g., ¾) and data rate (e.g., 1470 Mbsp).

In addition to using different MCS and modulation order values for Non-TB transmission, there are also advantages for applying different MCS or modulation orders to different spatial streams with UL TB transmissions. For example, for UL MU-MIMO transmissions when the number of receiver (AP) antennas is equal to total number of spatial streams, the transmitter STAs can apply implicit beamforming for the UL TB transmissions. Furthermore, explicit beamforming for UL MU transmission may also be considered for next generation WIFI standard, such as UHR. In UL TB mode, the AP sends a trigger frame to the non-AP STA(s) to trigger UL TB transmission. The trigger frame includes one user information field to each user scheduled to indicate the transmission parameters of the UL TB PPDU, including MCS. The New trigger frame user information field can either append extra bits to signal the new MCS rates or repurposes one or more subfields of the 802.11be EHT trigger frame user information field to indicate the new MCS rate to improve signaling efficiency and reduce complexity.

The Trigger Dependent User Info subfield in the Basic Trigger frame includes a reserved bit (bit position B5) that is set to 0 in the 802.11be specification. In accordance with the present disclosure, the reserved bit (bit position B15) is not needed, and can be repurposed to provide an “Unequal MCS” subfield which indicates whether different MCS or modulation orders are applied to different spatial streams when the trigger type is a Basic trigger. For example, the “Unequal MCS” subfield is set to 1 to indicate that different MCS or modulation orders are applied to different spatial streams in transmission, and is set to 0 to indicate that the same MCS or modulation order is applied to different spatial streams.

For example, a 4-bit Additional MCS subfield can be added at the end of Trigger Dependent User info to signal additional MCS values for use in encoding multiple spatial streams. In addition, a 3-bit (or 2-bit) Differential MCS subfield can be added at the end of Trigger Dependent User info to signal 3-bit (or 2-bit) differential MCS values for use in encoding multiple spatial streams. In addition, a 3-bit Modulation Order subfield can be added at the end of Trigger Dependent User info to signal additional modulation order values for use in encoding multiple spatial streams. In addition, a 2-bit (or 1-bit) Differential Modulation order subfield can be added at the end of Trigger Dependent User info to signal 2-bit (or 1-bit) differential modulation order values for use in encoding multiple spatial streams.

With the “Unequal MCS” subfield (Bit position B5) set to 1, this indicates that different MCS or modulation order values are applied to the second spatial streams group, as specified, respectively, in the Additional MCS subfield or the Modulation Order subfield. Similarly, the “Unequal MCS” subfield (Bit position B5) being set to 1 indicates that differential MCS or differential modulation order values are applied to the second spatial streams group, as specified, respectively, in the Differential MCS subfield or the Differential Modulation Order subfield.

If unequal MCS is not applied, the Additional MCS or Differential MCS subfield are reserved and set to 0.

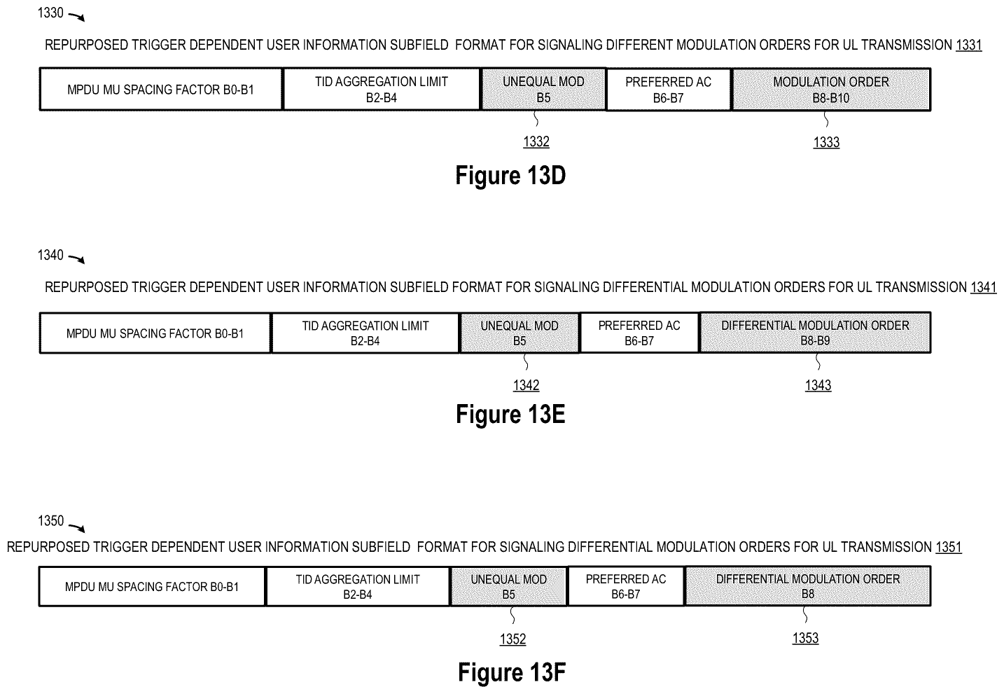

To provide additional details for an improved understanding of selected embodiments of the present disclosure, reference is now made to FIG. 13A which illustrates a signaling Trigger Frame User Info field 1300 having a repurposed trigger dependent user info subfield format 1301 for signaling additional MCS values used to encode different spatial streams for UL transmission with MU-MIMO allocations. As depicted, the signaling Trigger Frame User Info field 1300 (bit positions B0-B11) includes an Unequal MCS subfield 1302 (bit position B5) and an Additional MCS subfield 1303 (bit positions B8-B11) for specifying additional MCS values being applied to the second spatial streams group being used for UL transmission.

To provide additional details for an improved understanding of selected embodiments of the present disclosure, reference is now made to FIG. 13B which illustrates a signaling Trigger Frame User Info field 1310 having a repurposed trigger dependent user info subfield format 1311 for signaling differential MCS values used to encode different spatial streams for UL transmission with MU-MIMO allocations. As depicted, the signaling Trigger Frame User Info field 1310 (bit positions B0-B10) includes an Unequal MCS subfield 1312 (bit position B5) and a Differential MCS subfield 1313 (bit positions B8-B10) for specifying 3-bit differential MCS of the two spatial streams groups being used for UL transmission.

To provide additional details for an improved understanding of selected embodiments of the present disclosure, reference is now made to FIG. 13C which illustrates a signaling Trigger Frame User Info field 1320 having a repurposed trigger dependent user info subfield format 1321 for signaling differential MCS values used to encode different spatial streams for UL transmission with MU-MIMO allocations. As depicted, the signaling Trigger Frame User Info field 1330 (bit positions B0-B9) includes an Unequal MCS subfield 1312 (bit position B5) and a Differential MCS subfield 1323 (bit positions B8-B9) for specifying 2-bit differential MCS of the two spatial streams groups being used for UL transmission.

To provide additional details for an improved understanding of selected embodiments of the present disclosure, reference is now made to FIG. 13D which illustrates a signaling Trigger Frame User Info field 1330 having a repurposed trigger dependent user info subfield format 1331 for signaling different modulation order values used to encode different spatial streams for UL transmission with MU-MIMO allocations. As depicted, the signaling Trigger Frame User Info field 1330 (bit positions B0-B10) includes an Unequal MOD subfield 1332 (bit position B5) and a Differential Modulation Order subfield 1333 (bit positions B8-B10) for specifying modulation order values applied to the second spatial streams groups being used for UL transmission.

To provide additional details for an improved understanding of selected embodiments of the present disclosure, reference is now made to FIG. 13E which illustrates a signaling Trigger Frame User Info field 1340 having a repurposed trigger dependent user info subfield format 1341 for signaling differential modulation order values used to encode different spatial streams for UL transmission with MU-MIMO allocations. As depicted, the signaling Trigger Frame User Info field 1340 (bit positions B0-B9) includes an Unequal MOD subfield 1342 (bit position B5) and a Differential Modulation Order subfield 1343 (bit positions B8-B9) for specifying 2-bit differential modulation order values of the two spatial streams groups being used for UL transmission.

To provide additional details for an improved understanding of selected embodiments of the present disclosure, reference is now made to FIG. 13F which illustrates a signaling Trigger Frame User Info field 1350 having a repurposed trigger dependent user info subfield format 1351 for signaling differential modulation order values used to encode different spatial streams for UL transmission with MU-MIMO allocations. As depicted, the signaling Trigger Frame User Info field 1350 (bit positions B0-B8) includes an Unequal MOD subfield 1352 (bit position B5) and a Differential Modulation Order subfield 1353 (bit position B8) for specifying 1-bit differential modulation order of the two spatial streams groups being used for UL transmission.

In connection with the unequal modulations being used for spatial streams, there will be changes to the PPDU Data Padding and Encoding processes. For example, due to different modulation orders being used for different spatial streams, the number of coded bits per subcarrier per stream for user u, N_{BPSCS,u}, is no longer a value that can be applied to all spatial streams. Therefore, it is necessary to define the number of coded bits per subcarrier per stream with dependency on stream index N_{BPSCS,u,i}=log Mᵢ, where Mᵢ is the modulation order of spatial stream i, for i=0, . . . , N_{ss,u}−1. Similarly, the number of coded bits per OFDM symbol per spatial stream for user u, N_{CBPSS,u} should be replaced with N_{CBPSS,u,i}=N_{SD,u}·log Mᵢ, for i=0, . . . , N_{ss,u}−1, where N_{SD,u} is the number of effective data tones carrying unique data of user u.

Based on the definitions above, the number of coded bits per OFDM symbol can be calculated as N_{CBPS,u}=Σᵢ₌₀^{N}^{_{ss,u}}⁻¹N_{CBPSS,u,i}, and the number of data bits per OFDM symbol can be calculated as N_{DBPS,u}=Rᵤ·N_{CBPS,u}, where Rᵤ is the code rate of user u.

Based on the definitions above, the number of coded bits per OFDM symbol segment can be calculated as N_{CBPS,short,u}=Σᵢ₌₀^{N}^{_{ss,u}}⁻¹N_{SD,short,u}·N_{CBPCS,u,i}, and the number of data bits per OFDM symbol can be calculated as N_{DBPS,short,u}=Rᵤ·N_{CBPS,short,u}, where N_{SD,short,u} is defined as the number of effective data tones within each OFDM symbol segment corresponding to N_{SD,u}.

For all equations in the PPDU data padding and encoding process involving N_{DBPS,u}, N_{CBPS,u}, N_{DBPS,short,u} and N_{CBPS,short,u}, new definitions defined above should be used.

In addition, the unequal modulations being used for spatial streams means there will also be changes to the Stream parser and segment parser. For example, the number of bits assigned to real or imaginary axis in a constellation point in a spatial stream can vary for different spatial streams using unequal modulations. The number of bits assigned to spatial stream i for user u is defined as

$${s}_{u , i} = max ( 1 , \frac{{N}_{BPSCS , u , i}}{2} ) ,$$

for i=0, . . . , N_{ss,u}−1. The sum of these over all streams is

$${S}_{u} = {\sum }_{i = 0}^{{N}_{ss , u} - 1} {s}_{u , i} .$$

Based on the definitions above, the number of coded bits per OFDM symbol can be calculated as N_{CBPS,u}=Σₛ₌₀^{N}^{_{ss,u}}⁻¹N_{CBPSS,u,s}, and the number of data bits per OFDM symbol can be calculated as N_{DBPS,u}=Rᵤ·N_{CBPS,u}, where Rᵤ is the code rate of user u.

For segment parser used in 160 MHz and 320 MHz transmission with RU or MRU size greater than 996-tone, the N_{CBPSS,l,u} values, based on equal modulation, should be replaced with N_{CBPSS,l,u,i} for i=0, . . . , N_{ss,u}−1, where l is the index of each 80 MHz frequency subblock index. And N_{CBPSS,u,i}=ΣₗN_{CBPSS,l,u,i}, where l=0,1 for RU or MRU size larger than 996-tone and smaller than or equal to 2×996-tone, l=0,1,2 for RU or MRU size greater than 2×996-tone and smaller than or equal to 3×996-tone, l=0,1,2,3 for RU or MRU size greater than 3×996-tone.

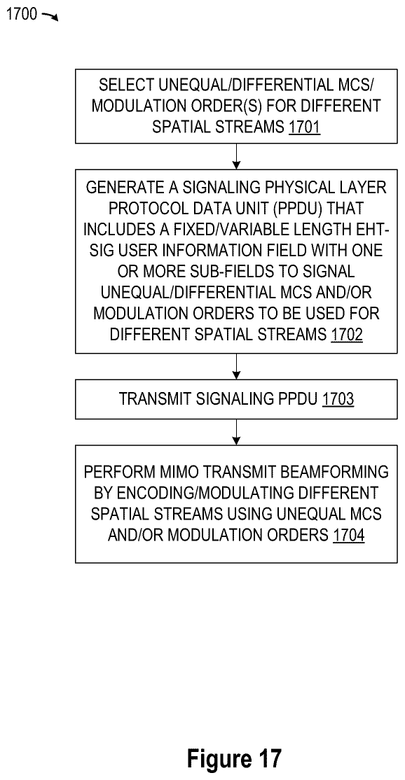

To provide additional details for an improved understanding of selected embodiments of the present disclosure, reference is now made to FIG. 17 which depicts an exemplary logic flow diagram 1700 to illustrate the operation of a wireless communication station (STA) device which uses unequal MCS/modulation order encoding and signaling procedure implemented. The method 1700 may be implemented by an AP STA 11 having a structure such as described with reference to FIG. 1, though the method 1700 may also be implemented by an AP or non-AP STA having a suitable structure different than illustrated in FIG. 1.

In various embodiments, the method 1700 is utilized in connection with any of the transmission sequences and data unit formats discussed in connection with any of FIGS. 2-16 and/or in connection with any of the techniques discussed above.

At step 1701, a first STA device (e.g., AP 11) selects an unequal or differential MCS or modulation order for use in encoding different spatial streams. With selected MU-MIMO transmit beamforming used with Non-TB transmissions, the first STA device may select a plurality of different MCS encoding values and/or a plurality of different modulation order encoding values for encoding different spatial streams based on channel condition number statistics, or other link adaptation statistics, such as SNR per spatial stream feedback. In addition or in the alternative, the first STA device may determine a plurality of differentials MCS encoding values and/or a plurality of differential modulation order encoding values which indicate value changes between neighboring spatial streams.

At step 1702, the first STA device generates a signaling physical layer protocol data unit (PPDU) that includes a fixed/variable length EHT-SIG user information field with one or more sub-fields to signal unequal or differential MCS and/or modulation orders to be used for different spatial streams. As described hereinabove, the signaling PPDU can be generated as a variable length EHT-SIG User info field for Non-TB transmission which includes a Length subfield header and a dedicated subfield which identifies the unequal or differential MCS and/or modulation order values that are applied to different spatial streams. Alternatively, the signaling PPDU can be generated as a fixed length EHT-SIG User info field for Non-TB transmission which includes a dedicated subfield which identifies the unequal or differential MCS and/or modulation order values that are applied to groups of spatial streams. Alternatively, the signaling PPDU can be generated as a repurposed EHT-SIG User info field for Non-TB transmission which includes dedicated subfields which identify the unequal or differential MCS and/or modulation order values that are applied to groups of spatial streams. Alternatively, the signaling PPDU can be generated as a repurposed Trigger frame User info field for UL transmission which includes dedicated subfields which identify the unequal or differential MCS and/or modulation order values that are applied to groups of spatial streams.

At step 1703, the first STA device transmits the signaling PPDU to notify a second STA (e.g., non-AP 21) that unequal or differential MCS and/or modulation orders will be used for different spatial streams in a data packet transmission.

At step 1704, the first STA device performs MIMO transmit beamforming of a data packet by encoding and/or modulating different spatial streams using the different MCS encoding values and/or different modulation order encoding values selected at step 1401.

By now it should be appreciated that there has been provided an apparatus, method, and system for signaling a plurality of different spatial stream encoding values by a first station (STA) device to a second STA device in a wireless personal area network in accordance with IEEE 802.11 protocol. In the disclosed method, the first STA device generates a signaling physical layer protocol data unit (PPDU) which includes a dedicated user information field which directly or indirectly identifies a plurality of different modulation and coding selection (MCS) values or different modulation orders used to encode different spatial streams from a plurality of spatial streams Nss used in a MIMO transmission of a data packet for each scheduled user of the signaling PPDU.

In selected variable length embodiments, the dedicated user information field includes a 4-bit MCS field to indicate a base MCS value and a variable length additional MCS field to indicate MCS values for all spatial streams for each scheduled user for non-TB (trigger-based) transmission of the data packet. In such embodiments, the base MCS value indicates an MCS value of the first spatial stream. In other such embodiments, the variable length additional MCS field has a length that is dependent on a total number of spatial streams Nₛₛ for each scheduled user, and that is indicated in a length field at a beginning of the dedicated user information field. In other such embodiments, the variable length additional MCS field includes independent MCS bits for each individual spatial stream with stream index nₛₛ=2, . . . , Nₛₛ for each scheduled user for Non-TB transmission of the data packet. In selected embodiments, the independent MCS bits may be encoded as MCS values for each individual spatial stream with stream index nₛₛ=2, . . . , Nₛₛ. Alternatively, the independent MCS bits may be encoded as modulation order values for each individual spatial stream with stream index nₛₛ=2, . . . , Nₛₛ. In other such embodiments, the variable length additional MCS field includes differential MCS bits for each spatial stream with stream index nₛₛ=2, . . . , Nₛₛ for each scheduled user for Non-TB transmission of the data packet. In selected embodiments, the differential MCS bits for each spatial stream may be encoded relative to a neighboring spatial stream. Alternatively, the differential MCS bits may be encoded as an MCS value difference for each individual spatial stream. Alternatively, the differential MCS bits may be encoded as a modulation order difference for each individual spatial stream.

In selected fixed length embodiments of the disclosed method, the dedicated user information field includes a 4-bit MCS field to indicate the base MCS value and a fixed length additional MCS field to indicate MCS values for all spatial streams for each scheduled user for Non-TB transmission of the data packet. In such embodiments, the plurality of spatial streams Nss includes a disjoint first spatial streams group and a second spatial streams group, where a first MCS value of the first spatial streams group is indicated by the base MCS value and where a second MCS value of the second spatial streams group is indicated by the fixed length additional MCS field. In such embodiments, the first spatial streams group includes the spatial stream indices of

$${N}_{SS 1} ∈ ( 1 , ⌊ \frac{{N}_{SS}}{2} ⌋ )$$

and the second spatial streams group includes the spatial stream indices of

$${N}_{SS 2} ∈ ( ⌊ \frac{{N}_{SS}}{2} ⌋ + 1 , {N}_{SS} ) .$$

In other such embodiments, the fixed length additional MCS field indicates the second MCS value as an absolute MCS value of the second spatial streams group. In other such embodiments, the fixed length additional MCS field indicates the second MCS value as a differential MCS value relative to the first MCS value. In other such embodiments, the fixed length additional MCS field indicates an absolute modulation order of the second spatial streams group. In other such embodiments, the fixed length additional MCS field indicates a differential modulation order of the second spatial streams group relative to a modulation order of the first spatial streams group.

In selected embodiments of the disclosed method which repurposes one or more selected bits of the EHT-SIG user information field, one MCS type bit is defined in the dedicated user information field to indicate if additional MCS values are used for each scheduled user for Non-TB transmission of the data packet. In such embodiments, the dedicated user information field has a length and format of an EHT-SIG user information field, and the MCS type bit is one reserved or validated bit from the format of the EHT-SIG user information field. In addition, the dedicated user information field may include one or more repurposed bits that are defined to signal the additional new MCS values for all spatial streams jointly with a 4-bit MCS field. In addition, the 4-bit MCS field may indicate a base MCS value and the one or more repurposed bits may indicate the additional MCS information for all spatial streams. In addition, the base MCS value may be an MCS index for a first spatial stream. In addition, the one or more repurposed bits may indicate a differential MCS value for each spatial stream pair with stream index nₛₛ=2, . . . , Nₛₛ. Alternatively, the one or more repurposed bits may indicate a differential modulation order for each spatial stream pair with stream index nₛₛ=2, . . . , Nₛₛ.

In selected embodiments where the MCS type bit is one reserved or validated bit from the format of the EHT-SIG user information field to indicate if additional MCS values are used for each scheduled user for Non-TB transmission of the data packet, the dedicated user information field may include a 4-bit MCS field that is repurposed to signal additional new MCS values for all spatial streams if additional new MCS values are indicated by the one reserved or validated bit. In such embodiments, the repurposed 4-bit MCS field may indicate additional new MCS values differently for each specific total number of spatial streams signaled by an Nss field. In selected embodiments, the repurposed 4-bit MCS field of the dedicated user information field may signal an MCS index value for a first unequal modulation MCS table with a plurality of entries, where each entry specifies unique unequal modulation order combinations for two spatial streams used for each scheduled user for Non-TB transmission of the data packet. In other selected embodiments, the repurposed 4-bit MCS field of the dedicated user information field may signal an MCS index value for a second unequal modulation MCS table with a plurality of entries, where each entry specifies unique unequal modulation order combinations for three spatial streams used for each scheduled user for Non-TB transmission of the data packet. In other selected embodiments, the repurposed 4-bit MCS field of the dedicated user information field may signal an MCS index value for a third unequal modulation MCS table with a plurality of entries, where each entry specifies unique unequal modulation order combinations for four spatial streams used for each scheduled user for Non-TB transmission of the data packet.

In selected embodiments of the disclosed method which repurposes one or more selected bits of the EHT trigger frame user information field, one MCS type bit is defined in the dedicated user information field to indicate if additional MCS values are used for each scheduled user for UL TB transmission of the data packet. In such embodiments, the dedicated user information field has a length and format of an EHT trigger frame user information field, and the MCS type bit is one reserved bit from the format of the EHT trigger frame user information field. In addition, the dedicated user information field may include one or more repurposed bits that are defined to signal the additional new MCS values for all spatial streams jointly with a 4-bit MCS field. In addition, the 4-bit MCS field may indicate a base MCS value, and the one or more repurposed bits may indicate a differential MCS value for each spatial stream pair with stream index nₛₛ=2, . . . , Nₛₛ. Alternatively, the 4-bit MCS field may indicate a base MCS value, and the one or more repurposed bits may indicate a differential modulation order for each spatial stream pair with stream index nₛₛ=2, . . . , Nₛₛ.

In selected embodiments where the MCS type bit is one reserved bit from the format of the EHT trigger user information field to indicate if additional MCS values are used for each scheduled user for UL TB transmission of the data packet, the dedicated user information field may include a 4-bit MCS field that is repurposed to signal additional new MCS values for all spatial streams if additional new MCS values are indicated by the one reserved bit. In such embodiments, the repurposed 4-bit MCS field may indicate additional new MCS values differently for each specific total number of spatial streams signaled by the Nss field. In selected embodiments, the repurposed 4-bit MCS field of the dedicated user information field may signal an MCS index value for a first unequal modulation MCS table with a plurality of entries, where each entry specifies unique unequal modulation order combinations for two spatial streams used for each scheduled user for UL TB transmission of the data packet. In other selected embodiments, the repurposed 4-bit MCS field of the dedicated user information field may signal an MCS index value for a second unequal modulation MCS table with a plurality of entries, where each entry specifies unique unequal modulation order combinations for three spatial streams used for each scheduled user for UL TB transmission of the data packet. In other selected embodiments, the repurposed 4-bit MCS field of the dedicated user information field may signal an MCS index value for a third unequal modulation MCS table with a plurality of entries, where each entry specifies unique unequal modulation order combinations for four spatial streams used for each scheduled user for UL TB transmission of the data packet.

In another form, there is provided a wireless device, apparatus, method, and system for selecting, signaling, and encoding a data packet using MIMO transmit beamforming over multiple spatial streams. As disclosed, the wireless device includes a processor that is configured to signal a plurality of different spatial stream encoding values to a second wireless device in a wireless personal area network in accordance with IEEE 802.11 protocol. To this end, the processor is configured to generate a signaling physical layer protocol data unit (PPDU) which includes a dedicated user information field which directly or indirectly identifies a plurality of different modulation and coding selection (MCS) values or different modulation orders used to encode different spatial streams from a plurality of spatial streams Nss used in a MIMO transmission of a data packet for each scheduled user of the signaling PPDU. In addition, the processor is configured to transmit the signaling PPDU to the second wireless device.

In yet another form, there is provided an apparatus, method, system, and program code for transmitting data packets in a wireless personal area network in accordance with IEEE 802.11 protocol. As disclosed the apparatus includes a transceiver to exchange data with a wireless device, a processor, and a memory storing instructions. When executed by the processor, the instructions cause the apparatus to generate a signaling physical layer protocol data unit (PPDU) which includes a dedicated user information field which directly or indirectly identifies a plurality of different modulation and coding selection (MCS) values or different modulation orders used to encode different spatial streams from a plurality of spatial streams Nss used in a MIMO transmission of a data packet for each scheduled user of the signaling PPDU. The addition, the instructions, when executed by the processor, cause the apparatus to transmit the signaling PPDU to the wireless device.

Although the described exemplary embodiments disclosed herein are directed to wireless communication station (STA) devices which use 802.11be encoding techniques to modulate multiple spatial streams, the present invention is not necessarily limited to the example embodiments which illustrate inventive aspects of the present invention that are applicable to a wide variety of circuit designs and operations. Thus, the particular embodiments disclosed above are illustrative only and should not be taken as limitations upon the present invention, as the invention may be modified and practiced in different but equivalent manners apparent to those skilled in the art having the benefit of the teachings herein. Accordingly, the identification of the circuit design and configurations provided herein is merely by way of illustration and not limitation and other circuit arrangements may be used. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

At least some of the various blocks, operations, and techniques described above may be implemented utilizing hardware, a processor executing firmware instructions, a processor executing software instructions, or any combination thereof. When implemented utilizing a processor executing software or firmware instructions, the software or firmware instructions may be stored in any computer readable memory such as on a magnetic disk, an optical disk, or other storage medium, in a RAM or ROM or flash memory, processor, hard disk drive, optical disk drive, tape drive, etc. The software or firmware instructions may include machine readable instructions that, when executed by one or more processors, cause the one or more processors to perform various acts. When implemented in hardware, the hardware may comprise one or more of discrete components, an integrated circuit, an application-specific integrated circuit (ASIC), a programmable logic device (PLD), etc.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1.-42. (canceled)

43. A method for signaling a plurality of different spatial stream encoding values by a first station (STA) device to a second STA device in a wireless personal area network in accordance with IEEE 802.11 protocol, comprising:
generating, by the first STA device, a signaling field in a physical layer protocol data unit (PPDU) which directly or indirectly identifies a plurality of different modulation and coding selection (MCS) values or different modulation orders used to encode different spatial streams from a plurality of spatial streams Nss used in a MIMO transmission of a data packet for each scheduled user of the PPDU.

44. The method of claim 43, where the signaling field is part of a dedicated user information field.

45. The method of claim 44, where the dedicated user information field comprises an M-bit Nss field to indicate the total number of spatial streams and an N-bit MCS field to indicate a base MCS value; and a K-bit additional MCS field to indicate unequal modulation values for each scheduled user for non-TB (trigger-based) transmission of the data packet.

46. The method of claim 45, where the additional MCS field indicates if equal modulation or unequal modulation/MCS is used among multiple streams.

47. The method of claim 45, where the base MCS value indicates an MCS value of all spatial streams if additional MCS field indicates equal modulation.

48. The method of claim 45, where the base MCS value indicates an MCS value of a first spatial stream if additional MCS field indicates unequal modulation.

49. The method of claim 45, where the additional MCS field is encoded as modulation orders of all spatial streams with stream index nₛₛ=2, . . . , Nₛₛ.

50. The method of claim 45, where the additional MCS field is encoded as MCS values for all spatial streams with stream index nₛₛ=2, . . . , Nₛₛ.

51. The method of claim 49, where the modulation orders for all streams with stream index nₛₛ=2, . . . , Nₛₛ, are encoded as differential modulation order relative to a modulation order of a first spatial stream, for each individual spatial stream.

52. The method of claim 51, where the additional MCS field indicates a limited number of differential modulation orders of all spatial streams with stream index nₛₛ=2, . . . , Nₛₛ.

53. The method of claim 52, where a maximum differential modulation order is limited to 2.

54. The method of claim 52, where a maximum differential modulation order is limited to 1.

55. The method of claim 52, where number of different modulation order is limited to 3.

56. The method of claim 49, where different modulation orders for all streams with stream index nₛₛ=2, . . . , Nₛₛ, is signaled as a differential modulation order relative to a neighboring spatial stream.

57. The method of claim 49, where different modulation orders are signaled as an absolute modulation order for all streams with stream index nₛₛ=2, . . . , Nₛₛ.

58. The method of claim 45, where the additional MCS field has a variable length that is dependent on a total number of spatial streams Nₛₛ for each scheduled user indicated in the M-bit NSS field.

59. The method of claim 45, where the additional MCS field has a fixed length for any number of spatial streams for each scheduled user.

60. The method of claim 59, where the dedicated user information field has a length and format of an EHT-SIG user information field, and where the additional MCS field is repurposed with the reserved or validated bits from the format of the EHT-SIG user information field.

61. The method of claim 44, where the dedicated user information field comprises an M-bit NSS field to indicate a total number of spatial streams and an N-bit MCS field to indicate a MCS value and one MCS type bit to indicate a modulation type for each scheduled user for Non-TB transmission of the data packet.

62. The method of claim 61, where the N-bit MCS field is encoded as the MCS value for all spatial streams if the MCS type bit indicates equal MCS for all spatial streams.

63. The method of claim 61, where the N-bit MCS field is encoded as unequal modulation orders for all spatial streams with stream index nₛₛ=1, . . . , Nₛₛ if the MCS type bit indicates unequal modulation for all spatial streams.

64. The method of claim 61, where the N-bit MCS field is encoded as unequal MCS for all spatial streams with stream index nₛₛ=1, . . . , Nₛₛ if the MCS type bit indicates unequal MCS for all spatial streams.

65. The method of claim 63, where the MCS field signals additional new MCS values for all spatial streams.

66. The method of claim 63, where the MCS field indicates multi-stream unequal modulation values dependent on a total number of spatial streams signaled by the Nss field.

67. The method of claim 66, where the MCS field signals an MCS index value for a first unequal modulation MCS table with a plurality of entries, each entry specifying unique unequal modulation order combinations for two spatial streams used for each scheduled user for Non-TB transmission of the data packet.

68. The method of claim 66, where the MCS field signals an MCS index value for a second unequal modulation MCS table with a plurality of entries, each entry specifying unique unequal modulation order combinations for three spatial streams used for each scheduled user for Non-TB transmission of the data packet.

69. The method of claim 66, where the MCS field signals an MCS index value for a third unequal modulation MCS table with a plurality of entries, each entry specifying unique unequal modulation order combinations for four spatial streams used for each scheduled user for Non-TB transmission of the data packet.

70. The method of claim 44, where one MCS type bit is defined in the dedicated user information field to indicate if additional MCS values are used for each scheduled user for UL TB transmission of the data packet.

71. The method of claim 70, where the dedicated user information field has a length and format of an EHT trigger frame user information field, and where the MCS type bit is one reserved bit from the format of the EHT trigger frame user information field.

72. The method of claim 71, where the dedicated user information field comprises one or more repurposed bits that are defined to signal the additional new MCS values for all spatial streams jointly with a MCS field.

73. The method of claim 72, where the MCS field indicates a base MCS value, and the one or more repurposed bits indicate a differential MCS value for each spatial stream pair with stream index nₛₛ=2, . . . , Nₛₛ.

74. The method of claim 72, where the MCS field indicates a base MCS value, and the one or more repurposed bits indicate a differential modulation order for each spatial stream pair with stream index nₛₛ=2, . . . , Nₛₛ.

75. The method of claim 74, where the dedicated user information field comprises a MCS field that is repurposed to signal additional new MCS values for all spatial streams if additional new MCS values are indicated by the one reserved bit.

76. The method of claim 75, where the MCS field indicates additional new MCS values differently for each specific total number of spatial streams signaled by the Nss field.

77. A wireless device, comprising:
a processor configured to signal a plurality of different spatial stream encoding values to a second wireless device in a wireless personal area network in accordance with IEEE 802.11 protocol by:
generating a signaling physical layer protocol data unit (PPDU) which comprises a dedicated user information field which directly or indirectly identifies a plurality of different modulation and coding selection (MCS) values or different modulation orders used to encode different spatial streams from a plurality of spatial streams Nss used in a MIMO transmission of a data packet for each scheduled user of the signaling PPDU; and
transmitting the signaling PPDU to the second wireless device.

78. An apparatus for transmitting data packets in a wireless personal area network in accordance with IEEE 802.11 protocol, comprising:
a transceiver to exchange data with a wireless device;
a processor; and
a memory storing instructions that, when executed by the processor, cause the apparatus to:
generate a signaling physical layer protocol data unit (PPDU) comprising a dedicated user information field which directly or indirectly identifies a plurality of different modulation and coding selection (MCS) values or different modulation orders used to encode different spatial streams from a plurality of spatial streams Nss used in a MIMO transmission of a data packet for each scheduled user of the signaling PPDU; and
transmit the signaling PPDU to the wireless device.
